(19) United States
(12) Patent Application Publication
(10) Pub. No.: US 2025/0040580 A1
(43) Pub. Date: Feb. 6, 2025

(54) ALDEHYDE MIXTURES FOR FLAVOUR IMPROVEMENT

(71) Applicant: SYMRISE AG, Holzminden (DE)

(72) Inventors: Uwe BORNSCHEUER, Greifswald (DE); In Jung KIM, Pohang (KR); Holger ZORN, Wettenberg (DE); Torsten GEIßLER, Einbeck (DE); Jakob Peter LEY, Holzminden (DE); Christoph HARMS, Holzminden (DE); Susanne OTTE-HÖLSCHER, Halle (DE); Sina BRUNS, Holzminden (DE); Marco Alexander FRAATZ, Gießen (DE); Andreas Klaus HAMMER, Bad Nauheim (DE); Philipp HONOLD, Gerstetten (DE)

(73) Assignee: SYMRISE AG, Holzminden (DE)

(21) Appl. No.: 18/716,916

(22) PCT Filed: Dec. 7, 2021
(86) PCT No.: PCT/EP2021/084575

§ 371 Date: Jun. 5, 2024

(51) Int. Cl. A23L 27/20; A23L 27/00

(52) U.S. Cl. CPC A23L 27/2024; A23L 27/88

(57) ABSTRACT

The present invention relates to ingredients for improving the flavour of food products. It concerns flavouring compositions with 8Z, 11Z-heptadecadional, 8Z-heptadecenal and 7Z-hexadecenal and optionally further aldehydes. Furthermore, the present invention relates to preparations with improved taste characteristics comprising an inventive flavouring composition as well as the use of an inventive flavouring composition and a method for improving at least one taste characteristic in a preparation.

The present invention relates to ingredients for improving the flavour of food products. It concerns flavouring compositions with 8Z, 11Z-heptadecadienal, 8Z-heptadecenal and 7Z-hexadecenal and optionally further aldehydes. Furthermore, the present invention relates to preparations with improved taste characteristics comprising an inventive flavouring composition as well as the use of an inventive flavouring composition and a method for improving at least one taste characteristic in a preparation.

In the field of food products, there is a constant need for new, interesting flavour compositions, which are able to balance, modify, intensify or stress certain taste perceptions and/or the overall taste of a composition.

Aldehydes are aromatic substances, which naturally occur in food products. The aldehyde hexanal is present, e.g. in apples, pears, peaches and cherries. Above a certain concentration, aldehydes can exhibit a rancid, fishy or metallic taste, which is not desired.

The natural occurrence of some unsaturated aldehydes with one or more double bonds such as 8Z-heptadecenal, 8Z, 11Z-heptadecadienal or 8Z, 11Z, 14Z-heptadecatrienal has been reported in pressed juices of cucumber (Cucumber Aroma formation of cucumber (Cucumis sativus L.) and bitter gourd (Momordica charantia L.) by salt-squeezing, Journal of Home Economics of Japan Vol. 60 (2009) No. 10 p. 877-885) or the algae Ulva pertusa (Production of bioflavour by regeneration from protoplasts of Ulva pertusa (Ulvales, Chlorophyta) Hydrobiologia, 1990, Vol. 204, pp 143-149).

Additional efforts have been made to produce long chain aldehydes such as 8Z-heptadecenal, 8Z, 11Z-heptadecadienal, 8Z, 11Z, 14Z-heptadecatrienal from enzymes, which are extracted from Ulva pertusa (Specificity of the enzyme system producing long chain aldehydes in the green alga, Ulva pertusa, Phytochemistry, Vol. 28, No. 2, pp. 407-409, 1989). No mixtures of these aldehydes are described therein, especially not their taste and influence on the taste profile.

The odor of 8Z, 11Z-heptadecadienal is described as typical of algae (Production of bioflavour by regeneration from protoplasts of Ulva pertusa Hydrobiologia, 1990, Vol. 204, pp 143-149).

8Z-pentadecenal is known to be a naturally occurring constituent of cucumber (Kemp, A C15 aldehyde from Cucumis sativus, Phytochemistry, Volume 16, Issue 11, 1977, Pages 1831-1832). The flavour of 8Z-pentadecenal is described primarily as oily and flavour-enhancing properties on chicken and grilled beef (JP 2014043409).

There is especially a market need for natural flavourings according to the European guideline EG 1334/2008, which can be used in a variety of applications, such as e.g. in beverages to balance the taste, in convenience products to achieve an authentic, homemade taste or in desserts to stress certain accents of the preparation.

The primary task of the present invention was to provide a new flavouring mixture, which is able to positively influence the taste, preferably the taste and odour, of a preparation towards a more desired taste profile, preferably taste and odour profile, as well as corresponding methods and uses of such flavouring mixture.

The primary task of this invention was solved in a first aspect by providing a flavouring composition comprising or consisting of 8Z, 11Z-heptadecadienal, 8Z-heptadecenal and 7Z-hexadecenal, and optionally one or more compounds from the group consisting of 5Z, 8Z, 12Z-heptadecatrienal, 8Z-pentadecenal and 7Z-tetradecenal.

It was observed that a flavouring composition comprising the aldehydes 8Z, 11Z-heptadecadienal, 8Z-heptadecenal and 7Z-hexadecenal was able to convey particularly desired taste characteristics in a preparation, e.g. enhancing the juicy odour and taste of citrus lemonades, even though the taste and odour profiles of most of the aldehydes are described as being typically for cucumber or algae.

One preferred embodiment of the present invention relates to a flavouring composition comprising or consisting of 8Z, 11Z-heptadecadienal, 8Z-heptadecenal, 7Z-hexadecenal and 5Z, 8Z, 12Z-heptadecatrienal.

Another preferred embodiment of the present invention relates to a flavouring composition comprising or consisting of 8Z, 11Z-heptadecadienal, 8Z-heptadecenal, 7Z-hexadecenal and 8Z-pentadecenal.

Yet another preferred embodiment of the present invention relates to a flavouring composition comprising or consisting of 8Z, 11Z-heptadecadienal, 8Z-heptadecenal, 7Z-hexadecenal and 7Z-tetradecenal.

One preferred embodiment of the present invention relates to a flavouring composition comprising or consisting of 8Z, 11Z-heptadecadienal, 8Z-heptadecenal and 7Z-hexadecenal, 5Z, 8Z, 12Z-heptadecatrienal and 8Z-pentadecenal.

Another preferred embodiment of the present invention relates to a flavouring composition comprising or consisting of 8Z, 11Z-heptadecadienal, 8Z-heptadecenal, 7Z-hexadecenal, 8Z-pentadecenal and 7Z-tetradecanal.

Yet another preferred embodiment of the present invention relates to a flavouring composition comprising or consisting of 8Z, 11Z-heptadecadienal, 8Z-heptadecenal, 7Z-hexadecenal, 5Z, 8Z, 12Z-heptadecatrienal and 7Z-tetradecenal.

Another preferred embodiment of the present invention relates to a flavouring composition comprising or consisting of 8Z, 11Z-heptadecadienal, 8Z-heptadecenal, 7Z-hexadecenal, 5Z, 8Z, 12Z-heptadecatrienal, 8Z-pentadecenal and 7Z-tetradecenal.

One embodiment of the present invention relates to a flavouring composition, wherein
8Z, 11Z-heptadecadienal is contained in an amount of from 0.0001 to 30 wt.-%, preferably in an amount of from 0.001 to 30 wt.-%, more preferably in an amount of from 0.01 to 30 wt.-%, and/or
8Z-heptadecenal is contained in an amount of from 0.0001 to 30 wt.-%, preferably in an amount of from 0.001 to 30 wt.-%, more preferably in an amount of from 0.01 to 30 wt.-%, and/or
7Z-hexadecenal is contained in an amount of from 0.0001 to 30 wt.-%, preferably in an amount of from 0.001 to 30 wt.-%, more preferably in an amount of from 0.01 to 30 wt.-%, and/or
5Z, 8Z, 12Z-heptadecatrienal, if present, is contained in an amount of from 0.0001 to 20 wt.-%, preferably in an amount of from 0.001 to 20 wt.-%, more preferably in an amount of from 0.01 to 20 wt.-%, and/or
8Z-pentadecenal, if present, is contained in an amount of from 0.0001 to 20 wt.-%, preferably in an amount of from 0.001 to 20 wt.-%, more preferably in an amount of from 0.01 to 20 wt.-%, and/or
7Z-tetradecenal, if present, is contained in an amount of from 0.0001 to 20 wt.-%, preferably in an amount of from 0.001 to 20 wt.-%, more preferably in an amount of from 0.01 to 20 wt.-%,

in each case based on the total weight of the flavouring composition.

One preferred embodiment of the present invention relates to a flavouring composition, wherein
8Z, 11Z-heptadecadienal is contained in an amount of from 0.0001 to 30 wt.-%, preferably in an amount of from 0.001 to 30 wt.-%, more preferably in an amount of from 0.01 to 30 wt.-%, and
8Z-heptadecenal is contained in an amount of from 0.0001 to 30 wt.-%, preferably in an amount of from 0.001 to 30 wt.-%, more preferably in an amount of from 0.01 to 30 wt.-%, and
7Z-hexadecenal is contained in an amount of from 0.0001 to 30 wt.-%, preferably in an amount of from 0.001 to 30 wt.-%, more preferably in an amount of from 0.01 to 30 wt.-%,

in each case based on the total weight of the flavouring composition.

Another preferred embodiment relates to a flavouring composition according to the present invention, wherein
8Z, 11Z-heptadecadienal is contained in an amount of from 0.0001 to 30 wt.-%, preferably in an amount of from 0.001 to 30 wt.-%, more preferably in an amount of from 0.01 to 30 wt.-%, and
8Z-heptadecenal is contained in an amount of from 0.0001 to 30 wt.-%, preferably in an amount of from 0.001 to 30 wt.-%, more preferably in an amount of from 0.01 to 30 wt.-%, and
7Z-hexadecenal is contained in an amount of from 0.0001 to 30 wt.-%, preferably in an amount of from 0.001 to 30 wt.-%, more preferably in an amount of from 0.01 to 30 wt.-%, and
5Z, 8Z, 12Z-heptadecatrienal is contained in an amount of from 0.0001 to 20 wt.-%, preferably in an amount of from 0.001 to 20 wt.-%, more preferably in an amount of from 0.01 to 20 wt.-%,

in each case based on the total weight of the flavouring composition.

Yet another preferred embodiment relates to a flavouring composition according to the present invention, wherein
8Z, 11Z-heptadecadienal is contained in an amount of from 0.0001 to 30 wt.-%, preferably in an amount of from 0.001 to 30 wt.-%, more preferably in an amount of from 0.01 to 30 wt.-%, and
8Z-heptadecenal is contained in an amount of from 0.0001 to 30 wt.-%, preferably in an amount of from 0.001 to 30 wt.-%, more preferably in an amount of from 0.01 to 30 wt.-%, and
7Z-hexadecenal is contained in an amount of from 0.0001 to 30 wt.-%, preferably in an amount of from 0.001 to 30 wt.-%, more preferably in an amount of from 0.01 to 30 wt.-%, and
5Z, 8Z, 12Z-heptadecatrienal, is contained in an amount of from 0.0001 to 20 wt.-%, preferably in an amount of from 0.001 to 20 wt.-%, more preferably in an amount of from 0.01 to 20 wt.-%, and
8Z-pentadecenal is contained in an amount of from 0.0001 to 20 wt.-%, preferably in an amount of from 0.001 to 20 wt.-%, more preferably in an amount of from 0.01 to 20 wt.-%,

in each case based on the total weight of the flavouring composition.

One preferred embodiment relates to a flavouring composition according to the present invention, wherein
8Z, 11Z-heptadecadienal is contained in an amount of from 0.0001 to 30 wt.-%, preferably in an amount of from 0.001 to 30 wt.-%, more preferably in an amount of from 0.01 to 30 wt.-%, and
8Z-heptadecenal is contained in an amount of from 0.0001 to 30 wt.-%, preferably in an amount of from 0.001 to 30 wt.-%, more preferably in an amount of from 0.01 to 30 wt.-%, and
7Z-hexadecenal is contained in an amount of from 0.0001 to 30 wt.-%, preferably in an amount of from 0.001 to 30 wt.-%, more preferably in an amount of from 0.01 to 30 wt.-%, and
7Z-tetradecenal, is contained in an amount of from 0.0001 to 20 wt.-%, preferably in an amount of from 0.001 to 20 wt.-%, more preferably in an amount of from 0.01 to 20 wt.-%, in each case based on the total weight of the flavouring composition.

Another preferred embodiment relates to a flavouring composition according to the present invention, wherein
8Z, 11Z-heptadecadienal is contained in an amount of from 0.0001 to 30 wt.-%, preferably in an amount of from 0.001 to 30 wt.-%, more preferably in an amount of from 0.01 to 30 wt.-%, and
8Z-heptadecenal is contained in an amount of from 0.0001 to 30 wt.-%, preferably in an amount of from 0.001 to 30 wt.-%, more preferably in an amount of from 0.01 to 30 wt.-%, and
7Z-hexadecenal is contained in an amount of from 0.0001 to 30 wt.-%, preferably in an amount of from 0.001 to 30 wt.-%, more preferably in an amount of from 0.01 to 30 wt.-%, and
5Z, 8Z, 12Z-heptadecatrienal, is contained in an amount of from 0.0001 to 20 wt.-%, preferably in an amount of from 0.001 to 20 wt.-%, more preferably in an amount of from 0.01 to 20 wt.-%, and
8Z-pentadecenal, is contained in an amount of from 0.0001 to 20 wt.-%, preferably in an amount of from 0.001 to 20 wt.-%, more preferably in an amount of from 0.01 to 20 wt.-%,

in each case based on the total weight of the flavouring composition.

Yet another preferred embodiment relates to a flavouring composition according to the present invention, wherein
8Z, 11Z-heptadecadienal is contained in an amount of from 0.0001 to 30 wt.-%, preferably in an amount of from 0.001 to 30 wt.-%, more preferably in an amount of from 0.01 to 30 wt.-%, and
8Z-heptadecenal is contained in an amount of from 0.0001 to 30 wt.-%, preferably in an amount of from 0.001 to 30 wt.-%, more preferably in an amount of from 0.01 to 30 wt.-%, and
7Z-hexadecenal is contained in an amount of from 0.0001 to 30 wt.-%, preferably in an amount of from 0.001 to 30 wt.-%, more preferably in an amount of from 0.01 to 30 wt.-%, and
8Z-pentadecenal, is contained in an amount of from 0.0001 to 20 wt.-%, preferably in an amount of from 0.001 to 20 wt.-%, more preferably in an amount of from 0.01 to 20 wt.-%, and
7Z-tetradecenal, is contained in an amount of from 0.0001 to 20 wt.-%, preferably in an amount of from 0.001 to 20 wt.-%, more preferably in an amount of from 0.01 to 20 wt.-%,

in each case based on the total weight of the flavouring composition.

One preferred embodiment relates to a flavouring composition according to the present invention, wherein
8Z, 11Z-heptadecadienal is contained in an amount of from 0.0001 to 30 wt.-%, preferably in an amount of from 0.001 to 30 wt.-%, more preferably in an amount of from 0.01 to 30 wt.-%, and
8Z-heptadecenal is contained in an amount of from 0.0001 to 30 wt.-%, preferably in an amount of from 0.001 to 30 wt.-%, more preferably in an amount of from 0.01 to 30 wt.-%, and
7Z-hexadecenal is contained in an amount of from 0.0001 to 30 wt.-%, preferably in an amount of from 0.001 to 30 wt.-%, more preferably in an amount of from 0.01 to 30 wt.-%, and
5Z, 8Z, 12Z-heptadecatrienal, is contained in an amount of from 0.0001 to 20 wt.-%, preferably in an amount of from 0.001 to 20 wt.-%, more preferably in an amount of from 0.01 to 20 wt.-%, and
7Z-tetradecenal, is contained in an amount of from 0.0001 to 20 wt.-%, preferably in an amount of from 0.001 to 20 wt.-%, more preferably in an amount of from 0.01 to 20 wt.-%,

in each case based on the total weight of the flavouring composition.

Another preferred embodiment relates to a flavouring composition according to the present invention, wherein
8Z, 11Z-heptadecadienal is contained in an amount of from 0.0001 to 30 wt.-%, preferably in an amount of from 0.001 to 30 wt.-%, more preferably in an amount of from 0.01 to 30 wt.-%, and
8Z-heptadecenal is contained in an amount of from 0.0001 to 30 wt.-%, preferably in an amount of from 0.001 to 30 wt.-%, more preferably in an amount of from 0.01 to 30 wt.-%, and
7Z-hexadecenal is contained in an amount of from 0.0001 to 30 wt.-%, preferably in an amount of from 0.001 to 30 wt.-%, more preferably in an amount of from 0.01 to 30 wt.-%, and
5Z, 8Z, 12Z-heptadecatrienal, is contained in an amount of from 0.0001 to 20 wt.-%, preferably in an amount of from 0.001 to 20 wt.-%, more preferably in an amount of from 0.01 to 20 wt.-%, and
8Z-pentadecenal, is contained in an amount of from 0.0001 to 20 wt.-%, preferably in an amount of from 0.001 to 20 wt.-%, more preferably in an amount of from 0.01 to 20 wt.-%, and
7Z-tetradecenal, is contained in an amount of from 0.0001 to 20 wt.-%, preferably in an amount of from 0.001 to 20 wt.-%, more preferably in an amount of from 0.01 to 20 wt.-%,

in each case based on the total weight of the flavouring composition.

One preferred embodiment of the invention relates to a flavouring composition according to the invention, wherein one, more or all of the aldehydes as described in context with the present invention, if present, is/are obtained by enzymatic conversion from one or more natural sources selected from the group consisting of palmitoleic acid, arachidonic acid, alpha-linolenic acid, oleic acid, punicic acid, alpha-elaeosteraric acid, docosahexaenoic acid, eicosapentaenoic acid, petroselic acid, chaulmoogric acid, alpha-licaric acid, olive oil, canola oil, macadamia nut oil, sea buckthorn fruit oil, tung oil, fish oil, borage oil, chaulmoogr oil, parsley oil, oiticica oil, pomegranate seed oil, coconut oil, sunflower oil, grape seed oil, and fungal oils obtained from any of the genera selected from Conidiobolus, Flammulina, Fomes, Ganoderma, Mortierella, Panellus, Pleurotus, Psathyrella, Stereum, Umbelopsis.

Preferably, the aldehydes as described in context with the present invention are obtained by enzymatic conversion as described in PCT/EP2020/056687.

“Natural source” describes every educt that exists without any actions of humankind, such as plants, animals and other vegetative organisms. In context with the present invention, the term natural source means any educt that is obtained from nature, e.g. as being a metabolite or an oil obtained from a plant, animal or other vegetative species such as fungi.

It is especially preferable in terms of the present invention, if the flavouring composition is completely or partly obtained by enzymatic conversion from macadamia nut oil, borage oil or sea buckthorn fruit oil.

An advantage of using natural educt source is that the obtained flavouring composition can be declared as natural flavouring according to the European guideline EG 1334/2008.

Another preferred embodiment relates to a flavouring composition according to the present invention, preferably partly obtained by enzymatic conversion as described herein, wherein the flavouring composition further comprises one or more additional flavourings selected from the group consisting of aliphatic flavouring substances, especially saturated aliphatic alcohols, such as ethanol, isopronanol, butanol, isoamyl alcohol, hexanol, 2-heptanol, (1/2/3)-octanol, decanol, unsaturated aliphatic alcohols, such as 2Z-pentenol, 3Z-hexenol, 2E-hexenol, 3E-hexenol, 2Z-octenol, 1-octen-3-ol, 6Z-nonenol, 2E, 6Z-nonadienol, aliphatic aldehydes such as saturated aliphatic aldehydes (e.g. acetaldehyde, propionaldehyde, butyraldehyde, isobutyraldehyde, valeraldehyde, isolvaleraldehyde, hexanal, 3-methyl hexanal, octanal, nonanal, or mono- or multi-unsaturated aliphatic aldehydes, such as 2-methyl-but-2-enal, 2E-hexenal, 3Z-hexenal, 4Z-hexenal, 2E-octenal, 2E-nonenal, 6Z-nonenal, 2E, 6Z-nonadienal, 2E-decenal, 2E-decadienal, aliphatic ketones, e.g. saturated ketones (such as 2-butanone, 2-pentanone, 2-heptanone, 2-octanone, 2-methylheptan-3-one, 2-decanone, 2-undecanone), unsaturated ketones (such as 1-penten-3-one, 1-hexen-3-one, 5-methyl-3-hexenone, 3-hepten-2-one, 1-octen-3-one, 2-octen-4-one, 3-octen-2-one, 3-none-2-one), aliphatic diketones and aliphatic diketoles, e.g. diacetyl, acetyl methyl carbinol, 2,3-hexanedione, aliphatic acids, such as straight-chain saturated acids, such as acetic acid, propionic acid, butyric acid, isobutyric acid, valeric acid, heptanoic acid, octanoic acid, decanoic acid, branched-chain saturated acids, such as 2-methyl heptanoic acid, 4-ethyl octanoic acid, and unsaturated acids, such as 2-butenoic acid, 2-pentenoic acid, 4-pentenoic acid, 2-methyl pentenoic acid, 3E-hexenoic acid, 3Z-hexenoic acid, 3-octenoic acid, linoleic acid, aliphatic esters, such as saturated esters, e.g. methyl acetate, methylbutyrate, methyl-2-methylbutyrate, methyl hexanoate, ethylacetate, ethylbutyrate, ethyl-2-methylbutyrate, ethyl-3-methylbutyrate, ethyl hexanoate, ethyl decanoate, isopropyl acetate, isobutyl acetate, isobutyl valerate, isoamyl acetate, isoamyl butyrate, isoamyl isovalerate, hexyl acetate, hexyl hexanoate, 3-octyl acetate and unsaturated esters, such as methyl 2-hexenoate, allyl hexanoate, 3Z-hexenyl acetate, 3Z-hexenyl butyrate, aliphatic thiols and dithiols (e.g. propane thiol, allyl mercaptan, 1-methoxy-3-methylbutane-3-thiol, dimethyl sulfide, dimethyl trisulfide, dipropyl sulfide, diallyl trisulfide, other aliphatic sulfur compounds, such as 2-mercapto-3-butanol, methyl thio propanal, 3-mercapto-pentanone, 4-methoxy-2-methyl-2-mercaptobutanone, methyl thiobutyrate, methyl thiobutyrate, methyl 3-methylthiopropionate, aliphatic nitrogen compounds, such as butyl amine, trimethyl amine, allyl isothiocyanate, isopropyl isothiocyanate, alicyclic compounds, such as alicyclic ketones, e.g. Z-jasmone, isophorone, 4-ketoisophorone, alicyclic esters such as methyl jasmonate, hedione, terpenes, e.g. terpene alcohols, such as linalool, citronellol, geraniol, nerol, alpha terpineol, menthol, 8-p-menthene-1,2-diol, fenchol, borneol, nerolidol, hotrienol, terpene aldehydes such as geranial, neral, citronellal, beta-sinensal, terpene ketones, such as alpha-ionone, (D)-carvone, (L)-carvone, nootkatone, piperitone, menthone, alpha damascone, beta damascene, damascenone, terpene esters, such as linalyl acetate, geranyl acetate, citronellyl actetate, carvyl acetate, fenchyl acetate, terpene sulphur compounds, 4-mentha-8-thiol-3-one, thiogeraniol, para-menth-1-ene-8-thiol, mercapto p-menthan-3-one, terpene hydrocarbons, such as (D)-limonene, (L)-limonene, alpha-pinene, beta-pinene, ocimene, alpha-terpinene, gamma-terpinene, beta-bisabolene, valencene, terpene oxides, such as 1,8-cineole, rose oxide, mint lactone, menthofuran, aromatic compounds, e.g. aromatic alcohols, such as benzyl alcohol, cinnamyl alcohol, 2-phenyl alcohol, aromatic aldehydes, such as benzaldehyde, cinnamic aldehyde, 5-methyl-2-phenylhexenal, salicylaldehyde, 4-hydroxy benzaldehyde, cyclamen aldehyde, 2-phenyl-2-butenal, aromatic acids, such as 2-phenyl acetic acid, cinnamic acid, aromatic esters such as benzyl acetate, benzyl salicylate, anisyl acetate, methyl phenyl acetate, methyl benzoate, methyl salicylate, methyl cinnamate, aromatic phenols, such as phenol, ortho-cresol, para-cresol, 2,3-dimethyl phenyl, 2-ethyl phenol, 2,3,5-trimethyl phenol, 4-vinyl phenol, guaiacol, 4-vinyl guaiacol, eugenol, thymol, carvacrol, aromatic sulphur compounds, such as thiophenol, diphenyl disulphide, aromatic nitrogen compounds, such as methyl anthranilate, methyl N-methyl anthranilate, aromatic ethers such as vanillin, ethylvanillin, anethol, aromatic oxides, such as heliotropine, diphenyl oxide, aromatic lactones, such as coumarin, dihydro coumarin, heterocyclic compounds, such as heterocyclic lactones, e.g. gamma butyrolactone, gamma-nonalactone, gamma decalactone, delta decalactone, jasmin lactone, delta dodecalactone, ambrettolide, heterocyclic furanes, such as furfuryl alcohol, furfural, 2-acetyl furan, theaspirane, 2-methyl tetrahydrofuran-3-one, furfuryl mercaptane, 2-methyl 3-furanthiol, 2-methyl 3-tetrahydro furanthiol, difurfuryl sulfide, difurfuryl disulfide, heterocyclic pyrans, such as maltol, ethyl maltole, rose oxide, maltol isobutyrate, heterocyclic pyrroles such as indole, 2-acetyle pyrrole, pyrrolidine, heterocyclic pyrazines, such as 2-methyl pyrazine, 2,3-dimethyl pyrazine, 2-methyl 3-ethyl pyrazine, trimethyl pyrazine, 2-acetyl pyrazine, 2-methoxy 3-methyl pyrazine, 2-methoxy 3-ethyl pyrazine, 2-methoxy 3-isobutyl pyrazine, 2-ethyl 3-methylthio pyrazine, heterocyclic thiazoles, such as thiazole, 2-methyl thiazole, 4-methyl 5-vinyl thiazole, 2-isobutyl thiazole, 2-acetyl thiazole,

flavouring raw materials and flavouring preparations, e.g. essential oils, concretes, absolutes, extract or tinctures from raw materials such as citrus (e.g. lemon, lime, tangerine, bergamotte, grapefruit bitter orange, peel or essence oils), herbs (dill, parsley, cumin, rosemary, sage, clary sage, basil, tarragon, thyme, oregano, savoury, marjoram, all spice, mace, nutmeg, clove leave, clove bud, caraway, cinnamon leaves, cinnamon bark, cassia, cardamom, ginger, galangal, turmeric, coriander seed, coriander leaf, fenugreek, juniper berry, wormwood, laurel leaves, eucalyptus, white pepper, green pepper, white pepper, carrot seed, celery seed, lovage leaf, asa foetida, onion, leek, garlic, mustard, horse radish, capsicum, paprika, sea weed, valerian oil, fir needle, spearmint, peppermint, wintergreen, buchu leaf, black currant buds, fennel, star anise, jambu, long pepper, davana, orris, mimosa, cassie, violet leaves, ho leaf, jasmin, ylang ylang, cananga, osmanthus, angelica, clary sage, ambrette seed, hops, camomile, lavender, rose, geranium, citronella, palmarosa, litsea cubeba, lemon grass, tagetes, neroli, petitgrain, mate, cognac oil, coffee, cola nut, cocoa, green tea, black tea, white tea, gentian, tolu balm, benzoe resin, peru balm, cascarilla, galbanum, vetiver, labdanum, patchouli, sandalwood, cedarwood, guaiac wood, oak wood, massoi bark, vanilla pods, tonka bean, as well as enriched fractions thereof,

juice concentrates, such as orange juice, lemon juice, strawberry, cherry juice, or passion fruit juice concentrates, water phases and recoveries from raw materials such as citrus (lemon, lime, orange, tangerine, grapefruit), apple, pear, quince, mispel, red fruits (raspberry, strawberry, blueberry, blackberry, Amellanchia (June plum), rose hip, cranberry, plum, prune, red and black currant, yellow fruits (peach, apricot, nectarine, banana, etc.), tropical fruits (mango, passionfruit, pineapple, lychee, etc.), vegetables (e.g. cucumber, tomato) and spices (e.g. ginger),

acetophenone, allyl caproate, alpha-ionone, beta-ionone, anisaldehyde, anisyl acetate, anisyl formate, benzaldehyde, benzothiazole, benzyl acetate, benzyl alcohol, benzyl benzoate, beta-ionone, butyl butyrate, butyl caproate, butylidene phthalide, carvone, camphene, caryophyllene, cineol, cinnamyl acetate, citral, citronellol, citronellal, citronellyl acetate, cyclohexyl acetate, cymene, damascone, decalactone, dihydrocoumarin, dimethyl anthranilate, dodecalactone, ethoxyethyl acetate, ethylbutyric acid, ethyl butyrate, ethyl caprate, ethyl caproate, ethyl crotonate, ethylfuraneol, ethylguaiacol, ethylisobutyrate, ethylisovalerate, ethyl lactate, ethylmethyl butyrate, ethyl propionate, eucalyptol, eugenol, ethyl heptylate, 4-(p-hydroxyphenyl)-2-butanone, gamma-decalactone, geraniol, geranyl acetate, geranyl acetate, grapefruit aldehyde, methyl dihydrojasmonate (e.g. Hedion®), heliotropin, 2-heptanone, 3-heptanone, 4-heptanone, 2E-heptenal, 4Z-heptenal, 2E-hexenal, 3Z-hexenol, 2E-hexenoic acid, 3E-hexenoic acid, 2Z-hexenyl acetate, 3Z-hexenyl acetate, 3Z-hexenyl caproate, 2E-hexenyl caproate, 3Z-hexenyl formate, 2Z-hexyl acetate, 3Z-hexyl acetate, 2E-hexyl acetate, 3Z-hexyl formate, para-hydroxybenzyl acetone, isoamyl alcohol, isoamyl isovalerate, isobutyl butyrate, isobutyraldehyde, isoeugenol methyl ether, isopropyl methylthiazole, lauric acid, levulinic acid, linalool, linalool oxide, linalyl acetate, menthol, menthofuran, methyl anthranilate, methylbutanol, methylbutyric acid, 2-methylbutyl acetate, methyl caproate, methyl cinnamate, 5-methylfurfural, 3,2,2-methylcyclopentenolone, 6,5,2-methylheptenone, methyl dihydrojasmonate, methyl jasmonate, 2-methylmethyl butyrate, 2-methyl-2-pentenol acid, methylthiobutyrate, 3,1-methylthiohexanol, 3-methylthiohexyl acetate, nerol, nerol acetate, 2E, 4E-nonadienal, 2,4-nonadienol, 2,6-nonadienol, 2,4-nonadienol, nootkatone, delta-octalactone, gamma-octalactone, 2-octanol, 3-octanol, 1,3-octenol, 1-octyl acetate, 3-octyl acetate, palmitic acid, paraldehyde, phellandrene, pentanedione, phenylethyl acetate, phenylethyl alcohol, phenylethyl isovalerate, piperonal, propionaldehyde, propyl butyrate, pulegone, pulegol, sinensal, sulfurol, terpinene, terpineol, terpinolene, 8,3-s thiomenthanone, 4,4,2-thiomethylpentanone, thymol, delta-undecalactone, gamma-undecalactone, valencene, valeric acid, vanillin, acetoin, ethylvanillin, ethylvanillin isobutyrate (=3-ethoxy-4-isobutyryloxybenzaldehyde), 2,5-dimethyl-4-hydroxy-3 (2H)-furanone and derivatives thereof (here preferably homofuraneol (=2-ethyl-4-hydroxy-5-methyl-3 (2H)-furanone), homofuronol (=2-ethyl-5-methyl-4-hydroxy-3 (2H)-furanone and 5-ethyl-2-methyl-4-hydroxy-3 (2H)-furanone), maltol and maltol derivatives (here preferably ethyl maltol), coumarin and coumarin derivatives, gamma-lactones (here preferably gamma-undecalactone, gamma-nonalactone, gamma-decalactone), delta-lactones (here preferably 4-methyldeltadecalactone, massoilactone, deltadecalactone, tuberolactone), methyl sorbate, divanillin, 4-hydroxy-2 (or 5)-ethyl-5 (or 2)-methyl-3 (2H) furanone, 2-hydroxy-3-methyl-2-cyclopentenone, 3-hydroxy-4,5-dimethyl-2 (5H)-furanone, acetic acid isoamyl ester, butyric acid ethyl ester, butyric acid-n-butyl ester, butyric acid isoamyl ester, 3-methyl-butyric acid ethyl ester, n-hexanoic acid ethyl ester, n-hexanoic acid allyl ester, n-hexanoic acid-n-butyl ester, n-octanoic acid ethyl ester, ethyl-3-methyl-3-phenylglycidate, ethyl-2-E-4-Z-decadienoate, 4-(p-hydroxyphenyl)-2-butanone, 1,1-dimethoxy-2,2,5-trimethyl-4-hexane, 2,6-dimethyl-5-hepten-1-al and phenylacetaldehyde, 2-methyl-3-(methylthio) furan, 2-methyl-3-furanthiol, bis(2-methyl-3-furyl)disulphide, furfurylmercaptan, methional, 2-acetyl-2-thiazoline, 3-mercapto-2-pentanone, 2,5-dimethyl-3-furanthiol, 2,4,5-trimethylthiazole, 2-acetylthiazole, 2,4-dimethyl-5-ethylthiazole, 2-acetyl-1-pyrroline, 2-methyl-3-ethylpyrazine, 2-ethyl-3,5-dimethylpyrazine, 2-ethyl-3,6-dimethylpyrazine, 2,3-diethyl-5-methylpyrazine, 3-isopropyl-2-methoxypyrazine, 3-isobutyl-2-methoxypyrazine, 2-acetylpyrazine, 2-pentylpyridine, (E,E)-2,4-decadienal, (E,E)-2,4-nonadienal, (E)-2-octenal, (E)-2-nonenal, 2-undecenal, 12-methyltridecanal, 1-penten-3-one, 4-hydroxy-2,5-dimethyl-3 (2H)-furanone, guaiacol, 3-hydroxy-4,5-dimethyl-2 (5H)-furanone, 3-hydroxy-4-methyl-5-ethyl-2 (5H)-furanone, cinnamaldehyde, cinnamon alcohol, methyl salicylate, isopulegol and (here not explicitly stated) stereoisomers, enantiomers, positional isomers, diastereomers, ZIE isomers or epimers of these substances.

It is especially preferably, if the flavouring composition according to the present invention comprises at least one additional flavouring selected from the group consisting of

decanol, hexanol, octanol, nonanol, borneol, iso-borneol, carveol, citronellol, p-cymol, elemol, ethanol, farnesol, fenchol, geraniol, Z-3-hexenal, E-2-hexenal, limetol, linalool, linalooloxide, 3,2-methylbuanol, nerol, nerolidol, E-2,6-nonadienol, 6-methyl-octanal, 1,3-pentenol, perilla aldehyde, sinensal fraction, 4-terpinenol, alpha-terpineol, acetaldehyde, acetaldehyde diethyl acetal, hexanal and acetals thereof such as hexanaldiethyl acetal, heptanal and acetals thereof, octanal and acetals thereof, nonanal and acetals thereof, decanal and acetals thereof, undecanal and acetals thereof, dodecanal and acetals thereof, citral, citronellal and acetals thereof such as citronellaldimethylacetal or diethylacetal, 2E, 4E-decadienal and acetals thereof as e.g. diethylacetal decanal, 2E-decenal, 4Z-decenal, 2E-dodecenal, melonal, methyltridecanal-12, 2E, 4E-nonadienal, 2E-nonenal, 6Z-nonenal, phenyl ethyl alcohol, benzyl acetate, bornyl acetate, bornyl formate,Z-I-carvyl acetate, citronellyl acetate, decyl acetate, dimethyl anthranilate, ethoxyethyl acetate, ethyl acetate, ethyl butyrate, ethyl capronate, ethyl caprylate, ethyl methyl butyrate, ethylhydroxy hexanoate, geranyl acetate, hedione, heptyl acetate, 3Z-hexenol, 3Z-hexenyl acetate, hexyl acetate, lauryl acetate, linalyl acetate, menthadienylacetate, menthyl acetate, methyl butyrate, methyl N-methyl anthanilate, neryl acetate, 1-octyl acetate, piperitanate, terpinyl acetate, amyris oil, angelica root oil, black currant flowers absolue, buchuleaf oil, camomile oil, campher oil, cananga oil java, cassie absolue, cedarwood oil, citronella oil, citrus peel and juice oils and their fractions from bergamotte, mandarine, tangerine, kalamansi, orange sweet and bitter, grapefruit, lemon, and lime, copaiba oil, coriander leaf and seed oil, cubeben oil, elimi oil, eucalyptus oil, galbanum oil, geranium oil, ginger oil, guajakwood oil, ho oil, jasmine oil, juniperberry oil, lavender oil, lemongrass oil, litsea cubaba oil, neroli oil, olibanum oil, orris oil, palmarosa oil, pepper black oil, petigrain oil, rose oil, rosemary oil, sage oil, spearmint and peppermint oil, tagetes oil, terpentine oil, thyme oil, violet leave oil, wintergreen oil, ylang ylang oil, camphor oil, 1,4-cineol, eucalyptol, coumarin-fraction, bisabolene beta-fraction, phellandrene-fraction, juice concentrates and waterphases from citrus, tropical fruits, pomaceous fruits and berry fruits, carvone, damascenon, alpha and/or beta ionone, alpha-irone, 6,5,2-methyl heptenone, p-methylacetophenone, 2-nonanone, nootkatone, 1,3-pentenon, piperitone, dihydrocoumarine, gamma-hexalactone, gamma-undecalactone, winelactone, thymol, vanillin, acetic acid, capric acid, caproic acid, caprylic acid, linoleic acid, myristic acid, 3-ethylmethyl thio propionate, 1,8-menthenthiol optionally ex grapefruit-methoxymethyl butanethiol-2,4,1,3-methylpropyloxathian, 3,3-methylthiobutylformiat, 3-methylmethyl thiopropionate, terpene thiols mix, thiocinneol, thiogeraniol, 3-thiohexanol, 3-thiohexylbutyrat, 3-thiohexylcapronate, 8,3-thiomenthanone, 4,4,2-thiomethylpentanone, camphene, 3-delta-carene, caryophyllene, caryophyllenoxide, limonene, myrcene, ocimene, pinene, alpha-, pinene, beta-, terpinene, gamma-, terpinolene, valencene fraction, or hotrienol,

Another preferred embodiment relates to a flavouring composition according to any the invention, wherein the flavouring composition, preferably partly obtained by enzymatic conversion as described herein, further comprises at least one compound or compound mixture conveying a sweet taste selected from the group consisting of natural sweeteners, preferably naturally occurring sweet tasting substances, including plant extracts, such as sweet tasting carbohydrates (such as sucrose, trehalose, lactose, maltose, melizitose, melibiose, raffinose, palatinose, lactulose, (D)-fructose, (D)-glucose, (D)-galactose, (L)-rhamnose, (D)-sorbose, (D)-mannose, (D)-tagatose, (D)-arabinose, (L)-arabinose, (D)-ribose, (D)-glyceraldehyde, maltodextrin), sugar alcohols (such as erythritol, threitol, arabitol, ribitol, xylitol, sorbitol, mannitol, maltitol, isomaltit, dulcitol, lactitol), proteins (such as miraculin, pentaidin, monellin, thaumatin, curculin, brazzein, mabinlin), (D)-amino acids (such as (D)-phenylalanine, (D)-tryptophan) or extracts or fractions obtained from natural sources containing these amino acids and/or proteins and the physiologically acceptable salts of these amino acids and/or proteins, particularly the sodium, potassium, calcium or ammonium salts thereof; neohesperidindihydrochalkon, naringindihydrochalkon, steviolgylcoside, stevioside, steviolbiosid, rebaudioside, rebaudioside A, rebaudioside B, rebaudioside C, rebaudioside D, rebaudioside E, rebaudioside F, rebaudioside G, rebaudioside H, rebaudioside M, rebaudioside N, rebaudioside X, dulcoside, rubusoside, suavioside A, suavioside B, suavioside G, suavioside H, suavioside I, suavioside J, baiyunoside 1, baiyunoside 2, phlomisoside 1, phlomisoside 2, phlomisoside 3, phlomisoside 4, abrusoside A, abrusoside B, abrusoside C, abrusoside D, cyclocaryoside A, cyclocaryoside I, oslandin, polypodoside A, strogin 1, strogin, 2, strogin 4, selligueanin A, dihydroquercetin-3-acetate, perillartin, telosmosid A15, periandrin I-V, pterocaryoside, cyclocaryoside, mukuroZioside, E-Anethol, E-cinnamaldehyd, bryoside, bryonoside, bryonodulcoside, carnosifloside, scandenoside, gypenoside, hematoxylin, cyanin, chlorogenic acid, albiZiasaponin, telosmoside, gaudichaudiosid, mogrosides, such as mogroside V, hernandulcine, monatin, glycyrrhetinic acid and its derivatives, particularly glycyrrhizin, preferably glycyrrhizin ammonium salt; extracts or enriched fractions of such extracts such as extracts of Thaumatococcus or Stevia ssp., particularly Stevia rebaudiana, swingle extracts, particularly Momordica or Siratia grosvenorii or Luo-Han-Guo, extracts of Glycerrhyzia ssp., particularly Glycerrhyzia glabra or Glycerrhyzia uralensis, extracts of Rubus ssp., particularly Rubus suavissimus or Rubus Chingii, extracts of Lippia dulcis, extracts of Mycetia balansae, preferably comprising balansin A and/or balansin B;

synthetic sweeteners, preferably synthetic sweet tasting substances, preferably selected from the group consisting of magap, sodium cyclamate or other physiologically acceptable salts of acesulfam cyclamic K; neohesperidindihydrochalcone, acid, naringindihydrochalcone, saccharin, saccharin sodium salt, aspartam, superaspartam, neotam, alitam, advantam, perillartin, sucralose, lugduname, carrelame, sucrononate or sucrooctate or mixtures thereof.

It is especially preferably, if the flavouring composition according to the present invention comprises at least one compound or compound mixture conveying a sweet taste selected from the group consisting of such as sucrose, trehalose, lactose, maltose, palatinose, (D)-fructose, (D)-glucose, (D)-galactose, (D)-tagatose, D-arabinose, I-arabinose, D-ribose, maltodextrin, erythritol, xylitol, sorbitol, mannitol, maltitol, isomaltit, monellin, thaumatin, brazzein, (D)-phenylalanine, (D)-tryptophan or extracts or fractions obtained from natural sources containing these amino acids and/or proteins and the physiologically acceptable salts of these amino acids and/or proteins, particularly the sodium, potassium, calcium or ammonium salts thereof; neohesperidindihydrochalkon, naringindihydrochalkon, steviolgylcoside, stevioside, steviolbiosid, rebaudioside, rebaudioside A, rebaudioside B, rebaudioside C, rebaudioside D, rebaudioside E, rebaudioside F, rebaudioside G, rebaudioside H, rebaudioside M, rebaudioside N, rebaudioside X, rubusoside, E-anethol, chlorogenic acid, mogrosides, such as mogroside V, hernandulcine, monatin, glycyrrhetinic acid and its derivatives, particularly glycyrrhizin, preferably glycyrrhizin ammonium salt; extracts or enriched fractions of such extracts such as extracts of Thaumatococcus or Stevia ssp., particularly Stevia rebaudiana, swingle extracts, particularly Momordica or Siratia grosvenorii or Luo-Han-Guo, extracts of Glycerrhyzia ssp., particularly Glycerrhyzia glabra, extracts of Rubus ssp., particularly Rubus suavissimus or Rubus chingii, extracts of Lippia dulcis, extracts of Mycetia balansae, preferably comprising balansin A and/or balansin B; sodium cyclamate, acesulfam K; neohesperidindihydrochalcone, naringindihydrochalcone, saccharin, saccharin sodium salt, aspartam, neotam, advantam or sucralose or mixtures thereof.

Another aspect of the present invention relates to a preparation comprising the flavouring composition according to the invention, wherein the flavouring composition is contained in an amount of from 0.001 to 10 ppm, preferably in an amount of from 0.01 to 5 ppm, especially preferably in an amount of from 0.015 to 0.5 ppm, based on the total weight of the preparation.

It was surprisingly found that preparations containing a very low amount of the flavouring composition according to the invention have a much more balanced taste profile and the desired characteristics of the preparation are enhanced.

One preferred embodiment of the preparation according to the invention relates to a preparation, wherein the preparation is selected from the group consisting of preparations suitable for consumption, preferably a foodstuff, preparations for pleasure, beverages, semi-finished products and oral hygiene products.

It is especially preferred if the preparation is a foodstuff, a preparation for pleasure or a beverage.

Another preferred embodiment of the preparation according to the invention relates to a preparation, wherein the preparation additionally comprises one or more (further) flavourings selected from the group consisting of

aliphatic flavouring substances, especially saturated aliphatic alcohols, such as ethanol, isopronanol, butanol, isoamyl alcohol, hexanol, 2-heptanol, (1/2/3)-octanol, decanol, unsaturated aliphatic alcohols, such as 2Z-pentenol, 3Z-hexenol, 2E-hexenol, 3E-hexenol, 2Z-octenol, 1-octen-3-ol, 6Z-nonenol, 2E, 6Z-nonadienol, aliphatic aldehydes such as saturated aliphatic aldehydes (e.g. acetaldehyde, propionaldehyde, butyraldehyde, isobutyraldehyde, valeraldehyde, isolvaleraldehyde, hexanal, 3-methyl hexanal, octanal, nonanal, or mono- or multi-unsaturated aliphatic aldehydes, such as 2-methyl-but-2-enal, 2E-hexenal, 3Z-hexenal, 4Z-hexenal, 2E-octenal, 2E-nonenal, 6Z-nonenal, 2E, 6Z-nonadienal, 2E-decenal, 2E-decadienal, aliphatic ketones, e.g. saturated ketones (such as 2-butanone, 2-pentanone, 2-heptanone, 2-octanone, 2-methylheptan-3-one, 2-decanone, 2-undecanone), unsaturated ketones (such as 1-penten-3-one, 1-hexen-3-one, 5-methyl-3-hexenone, 3-hepten-2-one, 1-octen-3-one, 2-octen-4-one, 3-octen-2-one, 3-none-2-one), aliphatic diketones and aliphatic diketoles, e.g. diacetyl, acetyl methyl carbinol, 2,3-hexanedione, aliphatic acids, such as straight-chain saturated acids, such as acetic acid, propionic acid, butyric acid, isobutyric acid, valeric acid, heptanoic acid, octanoic acid, decanoic acid, branched-chain saturated acids, such as 2-methyl heptanoic acid, 4-ethyl octanoic acid, and unsaturated acids, such as 2-butenoic acid, 2-pentenoic acid, 4-pentenoic acid, 2-methyl pentenoic acid, 3E-hexenoic acid, 3Z-hexenoic acid, 3-octenoic acid, linoleic acid, aliphatic esters, such as saturated esters, e.g. methyl acetate, methylbutyrate, methyl-2-methylbutyrate, methyl hexanoate, ethylacetate, ethylbutyrate, ethyl-2-methylbutyrate, ethyl-3-methylbutyrate, ethyl hexanoate, ethyl decanoate, isopropyl acetate, isobutyl acetate, isobutyl valerate, isoamyl acetate, isoamyl butyrate, isoamyl isovalerate, hexyl acetate, hexyl hexanoate, 3-octyl acetate and unsaturated esters, such as methyl 2-hexenoate, allyl hexanoate, 3Z-hexenyl acetate, 3Z-hexenyl butyrate, aliphatic thiols and dithiols (e.g. propane thiol, allyl mercaptan, 1-methoxy-3-methylbutane-3-thiol, dimethyl sulfide, dimethyl trisulfide, dipropyl sulfide, diallyl trisulfide, other aliphatic sulfur compounds, such as 2-mercapto-3-butanol, methyl thio propanal, 3-mercapto-pentanone, 4-methoxy-2-methyl-2-mercaptobutanone, methyl thiobutyrate, methyl thiobutyrate, methyl 3-methylthiopropionate, aliphatic nitrogen compounds, such as butyl amine, trimethyl amine, allyl isothiocyanate, isopropyl isothiocyanate, alicyclic compounds, such as alicyclic ketones, e.g. Z-jasmone, isophorone, 4-ketoisophorone, alicyclic esters such as methyl jasmonate, hedione, terpenes, e.g. terpene alcohols, such as linalool, citronellol, geraniol, nerol, alpha terpineol, menthol, 8-p-menthene-1,2-diol, fenchol, borneol, nerolidol, hotrienol, terpene aldehydes such as geranial, neral, citronellal, beta-sinensal, terpene ketones, such as alpha-ionone, (D)-carvone, (L)-carvone, nootkatone, piperitone, menthone, alpha damascone, beta damascene, damascenone, terpene esters, such as linalyl acetate, geranyl acetate, citronellyl actetate, carvyl acetate, fenchyl acetate, terpene sulphur compounds, 4-mentha-8-thiol-3-one, thiogeraniol, para-menth-1-ene-8-thiol, mercapto p-menthan-3-one, terpene hydrocarbons, such as (D)-limonene, (L)-limonene, alpha-pinene, beta-pinene, ocimene, alpha-terpinene, gamma-terpinene, beta-bisabolene, valencene, terpene oxides, such as 1,8-cineole, rose oxide, mint lactone, menthofuran, aromatic compounds, e.g. aromatic alcohols, such as benzyl alcohol, cinnamyl alcohol, 2-phenyl alcohol, aromatic aldehydes, such as benzaldehyde, cinnamic aldehyde, 5-methyl-2-phenylhexenal, salicylaldehyde, 4-hydroxy benzaldehyde, cyclamen aldehyde, 2-phenyl-2-butenal, aromatic acids, such as 2-phenyl acetic acid, cinnamic acid, aromatic esters such as benzyl acetate, benzyl salicylate, anisyl acetate, methyl phenyl acetate, methyl benzoate, methyl salicylate, methyl cinnamate, aromatic phenols, such as phenol, ortho-cresol, para-cresol, 2,3-dimethyl phenyl, 2-ethyl phenol, 2,3,5-trimethyl phenol, 4-vinyl phenol, guaiacol, 4-vinyl guaiacol, eugenol, thymol, carvacrol, aromatic sulphur compounds, such as thiophenol, diphenyl disulphide, aromatic nitrogen compounds, such as methyl anthranilate, methyl N-methyl anthranilate, aromatic ethers such as vanillin, ethylvanillin, anethol, aromatic oxides, such as heliotropine, diphenyl oxide, aromatic lactones, such as coumarin, dihydro coumarin, heterocyclic compounds, such as heterocyclic lactones, e.g. gamma butyrolactone, gamma-nonalactone, gamma decalactone, delta decalactone, jasmin lactone, delta dodecalactone, ambrettolide, heterocyclic furanes, such as furfuryl alcohol, furfural, 2-acetyl furan, theaspirane, 2-methyl tetrahydrofuran-3-one, furfuryl mercaptane, 2-methyl 3-furanthiol, 2-methyl 3-tetrahydro furanthiol, difurfuryl sulfide, difurfuryl disulfide, heterocyclic pyrans, such as maltol, ethyl maltole, rose oxide, maltol isobutyrate, heterocyclic pyrroles such as indole, 2-acetyle pyrrole, pyrrolidine, heterocyclic pyrazines, such as 2-methyl pyrazine, 2,3-dimethyl pyrazine, 2-methyl 3-ethyl pyrazine, trimethyl pyrazine, 2-acetyl pyrazine, 2-methoxy 3-methyl pyrazine, 2-methoxy 3-ethyl pyrazine, 2-methoxy 3-isobutyl pyrazine, 2-ethyl 3-methylthio pyrazine, heterocyclic thiazoles, such as thiazole, 2-methyl thiazole, 4-methyl 5-vinyl thiazole, 2-isobutyl thiazole, 2-acetyl thiazole,

flavouring raw materials and flavouring preparations, e.g. essential oils, concretes, absolutes, extract or tinctures from raw materials such as citrus (e.g. lemon, lime, tangerine, bergamotte, grapefruit bitter orange, peel or essence oils), herbs (dill, parsley, cumin, rosemary, sage, clary sage, basil, tarragon, thyme, oregano, savoury, marjoram, all spice, mace, nutmeg, clove leave, clove bud, caraway, cinnamon leaves, cinnamon bark, cassia, cardamom, ginger, galangal, turmeric, coriander seed, coriander leaf, fenugreek, juniper berry, wormwood, laurel leaves, eucalyptus, white pepper, green pepper, white pepper, carrot seed, celery seed, lovage leaf, asa foetida, onion, leek, garlic, mustard, horse radish, capsicum, paprika, sea weed, valerian oil, fir needle, spearmint, peppermint, wintergreen, buchu leaf, black currant buds, fennel, star anise, jambu, long pepper, davana, orris, mimosa, cassie, violet leaves, ho leaf, jasmin, ylang ylang, cananga, osmanthus, angelica, clary sage, ambrette seed, hops, camomile, lavender, rose, geranium, citronella, palmarosa, litsea cubeba, lemon grass, tagetes, neroli, petitgrain, mate, cognac oil, coffee, cola nut, cocoa, green tea, black tea, white tea, gentian, tolu balm, benzoe resin, peru balm, cascarilla, galbanum, vetiver, labdanum, patchouli, sandalwood, cedarwood, guaiac wood, oak wood, massoi bark, vanilla pods, tonka bean, as well as enriched fractions thereof,

juice concentrates, such as orange juice, lemon juice, strawberry, cherry juice, or passion fruit juice concentrates, water phases and recoveries from raw materials such as citrus (lemon, lime, orange, tangerine, grapefruit), apple, pear, quince, mispel, red fruits (raspberry, strawberry, blueberry, blackberry, Amellanchia (June plum), rose hip, cranberry, plum, prune, red and black currant, yellow fruits (peach, apricot, nectarine, banana, etc.), tropical fruits (mango, passionfruit, pineapple, lychee, etc.), vegetables (e.g. cucumber, tomato) and spices (e.g. ginger),

acetophenone, allyl caproate, alpha-ionone, beta-ionone, anisaldehyde, anisyl acetate, anisyl formate, benzaldehyde, benzothiazole, benzyl acetate, benzyl alcohol, benzyl benzoate, beta-ionone, butyl butyrate, butyl caproate, butylidene phthalide, carvone, camphene, caryophyllene, cineol, cinnamyl acetate, citral, citronellol, citronellal, citronellyl acetate, cyclohexyl acetate, cymene, damascone, decalactone, dihydrocoumarin, dimethyl anthranilate, dodecalactone, ethoxyethyl acetate, ethylbutyric acid, ethyl butyrate, ethyl caprate, ethyl caproate, ethyl crotonate, ethylfuraneol, ethylguaiacol, ethylisobutyrate, ethylisovalerate, ethyl lactate, ethylmethyl butyrate, ethyl propionate, eucalyptol, eugenol, ethyl heptylate, 4-(p-hydroxyphenyl)-2-butanone, gamma-decalactone, geraniol, geranyl acetate, geranyl acetate, grapefruit aldehyde, methyl dihydrojasmonate (e.g. Hedion®), heliotropin, 2-heptanone, 3-heptanone, 4-heptanone, 2E-heptenal, 4Z-heptenal, 2E-hexenal, 3Z-hexenol, 2E-hexenoic acid, 3E-hexenoic acid, 2Z-hexenyl acetate, 3Z-hexenyl acetate, 3Z-hexenyl caproate, 2E-hexenyl caproate, 3Z-hexenyl formate, 2Z-hexyl acetate, 3Z-hexyl acetate, 2E-hexyl acetate, 3Z-hexyl formate, para-hydroxybenzyl acetone, isoamyl alcohol, isoamyl isovalerate, isobutyl butyrate, isobutyraldehyde, isoeugenol methyl ether, isopropyl methylthiazole, lauric acid, levulinic acid, linalool, linalool oxide, linalyl acetate, menthol, menthofuran, methyl anthranilate, methylbutanol, methylbutyric acid, 2-methylbutyl acetate, methyl caproate, methyl cinnamate, 5-methylfurfural, 3,2,2-methylcyclopentenolone, 6,5,2-methylheptenone, methyl dihydrojasmonate, methyl jasmonate, 2-methylmethyl butyrate, 2-methyl-2-pentenol acid, methylthiobutyrate, 3,1-methylthiohexanol, 3-methylthiohexyl acetate, nerol, nerol acetate, 2E, 4E-nonadienal, 2,4-nonadienol, 2,6-nonadienol, 2,4-nonadienol, nootkatone, delta-octalactone, gamma-octalactone, 2-octanol, 3-octanol, 1,3-octenol, 1-octyl acetate, 3-octyl acetate, palmitic acid, paraldehyde, phellandrene, pentanedione, phenylethyl acetate, phenylethyl alcohol, phenylethyl isovalerate, piperonal, propionaldehyde, propyl butyrate, pulegone, pulegol, sinensal, sulfurol, terpinene, terpineol, terpinolene, 8,3-s thiomenthanone, 4,4,2-thiomethylpentanone, thymol, delta-undecalactone, gamma-undecalactone, valencene, valeric acid, vanillin, acetoin, ethylvanillin, ethylvanillin isobutyrate (=3-ethoxy-4-isobutyryloxybenzaldehyde), 2,5-dimethyl-4-hydroxy-3 (2H)-furanone and derivatives thereof (here preferably homofuraneol (=2-ethyl-4-hydroxy-5-methyl-3 (2H)-furanone), homofuronol (=2-ethyl-5-methyl-4-hydroxy-3 (2H)-furanone and 5-ethyl-2-methyl-4-hydroxy-3 (2H)-furanone), maltol and maltol derivatives (here preferably ethyl maltol), coumarin and coumarin derivatives, gamma-lactones (here preferably gamma-undecalactone, gamma-nonalactone, gamma-decalactone), delta-lactones (here preferably 4-methyldeltadecalactone, massoilactone, deltadecalactone, tuberolactone), methyl sorbate, divanillin, 4-hydroxy-2 (or 5)-ethyl-5 (or 2)-methyl-3 (2H) furanone, 2-hydroxy-3-methyl-2-cyclopentenone, 3-hydroxy-4,5-dimethyl-2 (5H)-furanone, acetic acid isoamyl ester, butyric acid ethyl ester, butyric acid-n-butyl ester, butyric acid isoamyl ester, 3-methyl-butyric acid ethyl ester, n-hexanoic acid ethyl ester, n-hexanoic acid allyl ester, n-hexanoic acid-n-butyl ester, n-octanoic acid ethyl ester, ethyl-3-methyl-3-phenylglycidate, ethyl-2-E-4-Z-decadienoate, 4-(p-hydroxyphenyl)-2-butanone, 1,1-dimethoxy-2,2,5-trimethyl-4-hexane, 2,6-dimethyl-5-hepten-1-al and phenylacetaldehyde, 2-methyl-3-(methylthio) furan, 2-methyl-3-furanthiol, bis(2-methyl-3-furyl)disulphide, furfurylmercaptan, methional, 2-acetyl-2-thiazoline, 3-mercapto-2-pentanone, 2,5-dimethyl-3-furanthiol, 2,4,5-trimethylthiazole, 2-acetylthiazole, 2,4-dimethyl-5-ethylthiazole, 2-acetyl-1-pyrroline, 2-methyl-3-ethylpyrazine, 2-ethyl-3,5-dimethylpyrazine, 2-ethyl-3,6-dimethylpyrazine, 2,3-diethyl-5-methylpyrazine, 3-isopropyl-2-methoxypyrazine, 3-isobutyl-2-methoxypyrazine, 2-acetylpyrazine, 2-pentylpyridine, (E,E)-2,4-decadienal, (E,E)-2,4-nonadienal, (E)-2-octenal, (E)-2-nonenal, 2-undecenal, 12-methyltridecanal, 1-penten-3-one, 4-hydroxy-2,5-dimethyl-3 (2H)-furanone, guaiacol, 3-hydroxy-4,5-dimethyl-2 (5H)-furanone, 3-hydroxy-4-methyl-5-ethyl-2 (5H)-furanone, cinnamaldehyde, cinnamon alcohol, methyl salicylate, isopulegol and (here not explicitly stated) stereoisomers, enantiomers, positional isomers, diastereomers, ZIE isomers or epimers of these substances.

Another preferred embodiment of the preparation according to the invention relates to a preparation, wherein the preparation additionally comprises at least one (further) compound or compound mixture conveying a sweet taste selected from the group consisting of

natural sweeteners, preferably naturally occurring sweet tasting substances, including plant extracts, such as sweet tasting carbohydrates (such as sucrose, trehalose, lactose, maltose, melizitose, melibiose, raffinose, palatinose, lactulose, (D)-fructose, (D)-glucose, (D)-galactose, (L)-rhamnose, (D)-sorbose, (D)-mannose, (D)-tagatose, (D)-arabinose, (L)-arabinose, (D)-ribose, (D)-glyceraldehyde, maltodextrin), sugar alcohols (such as erythritol, threitol, arabitol, ribitol, xylitol, sorbitol, mannitol, maltitol, isomaltit, dulcitol, lactitol), proteins (such as miraculin, pentaidin, monellin, thaumatin, curculin, brazzein, mabinlin), (D)-amino acids (such as (D)-phenylalanine, (D)-tryptophan) or extracts or fractions obtained from natural sources containing these amino acids and/or proteins and the physiologically acceptable salts of these amino acids and/or proteins, particularly the sodium, potassium, calcium or ammonium salts thereof; neohesperidindihydrochalkon, naringindihydrochalkon, steviolgylcoside, stevioside, steviolbiosid, rebaudioside, rebaudioside A, rebaudioside B, rebaudioside C, rebaudioside D, rebaudioside E, rebaudioside F, rebaudioside G, rebaudioside H, rebaudioside M, rebaudioside N, rebaudioside X, dulcoside, rubusoside, suavioside A, suavioside B, suavioside G, suavioside H, suavioside I, suavioside J, baiyunoside 1, baiyunoside 2, phlomisoside 1, phlomisoside 2, phlomisoside 3, phlomisoside 4, abrusoside A, abrusoside B, abrusoside C, abrusoside D, cyclocaryoside A, cyclocaryoside I, oslandin, polypodoside A, strogin 1, strogin, 2, strogin 4, selligueanin A, dihydroquercetin-3-acetate, perillartin, telosmosid A15, periandrin I-V, pterocaryoside, cyclocaryoside, mukuroZioside, E-Anethol, E-cinnamaldehyd, bryoside, bryonoside, bryonodulcoside, carnosifloside, scandenoside, gypenoside, hematoxylin, cyanin, chlorogenic acid, albiZiasaponin, telosmoside, gaudichaudiosid, mogrosides, such as mogroside V, hernandulcine, monatin, glycyrrhetinic acid and its derivatives, particularly glycyrrhizin, preferably glycyrrhizin ammonium salt; extracts or enriched fractions of such extracts such as extracts of Thaumatococcus or Stevia ssp., particularly Stevia rebaudiana, swingle extracts, particularly Momordica or Siratia grosvenorii or Luo-Han-Guo, extracts of Glycerrhyzia ssp., particularly Glycerrhyzia glabra or Glycerrhyzia uralensis, extracts of Rubus ssp., particularly Rubus suavissimus or Rubus Chingii, extracts of Lippia dulcis, extracts of Mycetia balansae, preferably comprising balansin A and/or balansin B;

synthetic sweeteners, preferably synthetic sweet tasting substances, preferably selected from the group consisting of magap, sodium cyclamate or other physiologically acceptable acesulfam K; neohesperidindihydrochalcone, salts of cyclamic acid, naringindihydrochalcone, saccharin, saccharin sodium salt, aspartam, superaspartam, neotam, alitam, advantam, perillartin, sucralose, lugduname, carrelame, sucrononate or sucrooctate or mixtures thereof.

Another aspect of the present invention relates to the use of the flavouring composition according to the invention, preferably as described in connection with one or more preferred embodiments above, for improving at least one taste characteristic in/of a preparation.

A “taste characteristic” in terms of the present invention may mean any taste or taste impression of a preparation, which can be modified/improved or created, such as a salty, sour, sweet, bitter, juicy, fruity, umami, kukumi, brothy, savory, aldehydic, fresh-tangy, fatty, oily or waxy taste, or (overall) taste impressions such as richness, body, authenticity, impact, mouthfeel, sweetness and juiciness.

One preferred embodiment relates to the use according to the invention, wherein the at least one taste characteristic(s) is/are selected from the group consisting of richness, body, authenticity, impact, mouthfeel, sweetness and juiciness.

“Richness” in terms of the present invention preferably means a balanced taste profile, wherein the desired taste is perceived as strong, pleasant main taste and certain side tastes are present in a way that they do not disturb the pleasant main taste but support it.

“Body” in terms of the present invention preferably means the desired main taste of a preparation. If the body taste of a preparation is enhanced, it has a stronger main taste.

“Impact” in terms of the present invention preferably means that the desired main taste has strong peaks in the taste perception, which makes the desired taste more interesting for the consumer.

“Mouthfeel” in terms of the present invention preferably means that the taste conveys a pleasant feeling in the mouth without spiking the single tastes sour, sweet, salty or savory/umami.

“Sweetness” in terms of the present invention preferably means the sweet taste of a preparation.

“Juiciness” in terms of the present invention preferably means a taste that conveys a fresh impression in the mouth, which is predominantly composed of sweet and sour taste impressions.

Another preferred embodiment relates to the use according to the invention, wherein the flavouring composition according to the invention is used in an amount of from 0.001 to 10 ppm, preferably in an amount of from 0.01 to 5 ppm, especially preferably in an amount of from 0.015 to 0.5 ppm, based on the total weight of the preparation.

As described above, it was surprisingly found that even a low dosing of the flavouring composition according to the present invention conveys an improvement in the desired taste characteristic.

Another aspect of the present invention relates to a method for improving at least one taste characteristic in/of a preparation, comprising or consisting of the steps
a) providing at least one preparation selected from the group consisting of preparations suitable for consumption, preferably a foodstuff, preparations for pleasure, beverages, semi-finished products and oral hygiene products, preferably as described herein;
b) providing a flavouring composition according to the invention, preferably as described herein above as preferred;
c) contacting and mixing the preparation provided in step a) and the flavouring composition provided in step b);
d) obtaining a preparation according to the invention, preferably as described above as preferred.

One preferred embodiment relates to a method according to the invention, wherein the flavouring composition provided in step b) is provided in an amount of from 0.001 to 10 ppm, preferably in an amount of from 0.01 to 5 ppm, especially preferably in an amount of from 0.015 to 0.5 ppm, based on the total weight of the preparation.

Again, as described above, it was surprisingly found that even a low provision of the flavouring composition according to the present invention in step b) conveys an improvement in the desired taste characteristic.

Further preferred embodiments of such uses and methods according to the present invention become apparent in view of the above described preferred embodiments in connection with preferred flavouring compositions and products, respectively.

In the following, exemplary specific embodiments are described in more detail, without the intention to limit the scope of the present invention.

The term “flavouring preparation” is used in the examples part to describe the mixture directly obtained from a natural source. In terms of the present invention, the described “flavouring preparation” is also a “flavouring composition” as claimed in connection with the present invention.

### EXAMPLES

### Example 1: Production of a Flavouring Preparation from Natural Sources

### 1. Borage Seed Oil

10 grams of borage seed oil were incubated with Candida antarctica Lipase B and tert-Butanol to hydrolyse the contained triglycerides. The reaction mixture containing free fatty acids from borage seed oil are extracted with methyl-tert-butylether (MTBE) und the solvent is evaporated in a subsequent step. The enriched free fatty acids from borage seed oil are subsequently incubated with an alpha-dioxygenase and an aldehyde dehydrogenase for obtaining the desired aldehydes, which are extracted with ethyl acetate after finishing the enzymatic treatment. 1.8 g of the flavouring preparation according to the invention is obtained after evaporating the solvent and subsequent ball distillation.

### 2. Macadamia Nut Oil

10 grams of macadamia nut oil is incubated with Candida antarctica Lipase B and tert-Butanol to hydrolyse the contained triglycerides. The reaction mixture containing free fatty acids from macadamia nut oil are extracted with MTBE und the solvent is evaporated in a subsequent step. The purified free fatty acids from macadamia nut oil are subsequently incubated with an alpha-dioxygenase and an aldehyde dehydrogenase for obtaining the desired aldehydes, which are extracted with ethyl acetate after finishing the enzymatic treatment. 0.66 g flavouring preparation according to the invention is obtained after evaporating the solvent and subsequent ball distillation.

### Example 2: Analytic of the Obtained Flavouring Preparations from Example 1

The obtained flavouring preparations were analysed via gas chromatography and gas chromatography coupled to a mass spectrometer (GC-MS). Samples were diluted 1:300 using ethyl acetate prior to analysis.

The following conditions were used:
(1) Gas chromatography: Inj. volume: 1 μL; run time: 45 min; column info: 15 m MXT-1 (HT) 0.1 M df; ID: 0.25 mm/60° C.-10° C./min−380° C. PTV
(2) Gas chromatography-MS: column info: 20 m ZB-1, 60-9-300, Split 30).

The following results regarding the aldehydes of the flavouring preparation according to the present invention were obtained for borage seed oil and macadamia nut oil:

### 1. Borage Seed Oil

TABLE 1
GC-MS results for a flavouring preparation
prepared from borage seed oil.

| Aldehyde | Peak Area [%] | Time |
|---|---|---|
| Tridecanal | 0.452 | 5.833 |
| 6Z-,9Z- | 0.225 | 7.983 |
| pentadecadienal | | |
| Tetradecanal | 2.283 | 12.772 |
| 8Z-pentadecenal | 0.211 | 13.740 |
| Pentadecenal | 8.685 | 14.072 |
| Hexadecatrienal | 0.458 | 14.669 |
| 7Z-,10Z- | 5.615 | 14.843 |
| hexadecadienal | | |
| 7Z-hexadecenal | 1.548 | 14.948 |
| Hexadecenal | 0.350 | 15.244 |
| Heptadecatrienal | 5.730 | 15.850 |
| 8Z,11Z- | 22.395 | 16.064 |
| heptadecadienal | | |
| 8Z-heptadecenal | 17.528 | 16.171 |
| Heptadecanal | 5.519 | 16.430 |
| Nonadecenal | 2.641 | 18.259 |

### 2. Macadamia Nut Oil

TABLE 2
GC-MS results for a flavouring preparation
prepared from macadamia nut oil.

| Aldehyde | Peak Area [%] | Time |
|---|---|---|
| 12Z-Tridecanal | 0.373 | 11.007 |
| Tridecanal | 0.274 | 11.293 |
| 7Z-tetradecenal | 1.189 | 12.335 |
| Tetradecanal | 0.430 | 12.630 |
| 8Z-pentadecenal | 5.357 | 13.619 |
| Pentadecenal | 2.533 | 13.906 |
| 7Z-hexadecenal | 1.683 | 14.807 |
| 8Z-,11Z- | 0.446 | 15.841 |
| heptadecadienal | | |
| 8Z-heptadecenal | 12.611 | 15.974 |
| Heptadecanal | 0.752 | 16.261 |
| Nonadecenal | 0.537 | 18.108 |

### Example 3: Sensory Evaluation of the Flavouring Preparation

The obtained and analyzed flavouring compositions were used in different dosing regimens of and tasted by a panel consisting of five to eight educated panellists. The tasting base solution is an aqueous solution with 8 wt.-% sucrose and 0.15 wt.-% citric acid dependent on the total mass of the aqueous solution. The tests were conducted by comparing the taste of the aqueous solution after adding a dosage of an essence oil to a dosage of an essence oil and the respective flavouring composition.

### 1. Borage Seed Oil

Table 3 shows the results of the tests with a flavouring preparation obtained from borage seed oil as described in Examples 1 and 2.

TABLE 3
Results of the sensorial experiments with a flavouring
preparation manufactured from borage seed oil.

| Sample | Dosage | Odor | Taste |
|---|---|---|---|
| Essence oil orange | 25 ppm | fruity, essence, ripe, | fruity, essence, ripe, |
| | | juicy, slightly aldehydic | juicy, slightly aldehydic |
| Essence oil orange + | 25 ppm plus | lift, more impact | sweeter, fuller, riper, |
| flavouring composition | 0.05 ppm | | more body |
| Essence oil tangerine | 12 ppm | fruity, methyl anthranilate, | fruity, methyl anthranilate, |
| | | juicy, slightly aldehydic- | juicy, slightly aldehydic- |
| | | fishy | fishy |
| Essence oil tangerine + | 12 ppm plus | more impact, stronger, | more body, impact, |
| flavouring preparation | 0.015 ppm | more candy-anthranilate, | slightly fishy, more typical |
| | | more fishy, more albedo- | |
| | | peely | |

Additionally to testing the flavouring preparation in a model solution, the flavouring composition was also added in dosing regimens of 0.01 to 0.08 g/L of a 0.1 wt.-% solution in triacetin to commercially available citrus lemonades. The overall observed influence on the odor and the taste of the preparations was described by the panelists as that the addition of the flavouring preparation leads to a lift of aldehydic-zesty and albedo-peely notes in the odor. Additionally the odor was fresher and more juicy. The taste is described as having more body and more impact, conveying a sweeter and fuller mouthfeel and being more albedo-aldehydic and fatty-waxy as desired for these types of beverages.

The beverage application examples are displayed in Table 4.

TABLE 4
Beverage formulations containing the aldehyde mixture
from borage seed oil or macadamia nut oil.

| | Orange | | Near |
|---|---|---|---|
| | carbonated | Isotonic | water |
| | soft drink | grapefruit | mandarine |
| Ingredient | [g/L] | [g/L] | [g/L] |
| Ascorbic acid | 0.40 | 0.40 | — |
| Citric acid | 2.10 | — | 1.30 |
| Sweetener mix | — | 0.30 | — |
| Invert sugar | 100.00 | — | 35.00 |
| syrup 72.7 wt.-% | | | |
| Fructose syrup | — | 15.00 | — |
| 95 wt.-% | | | |
| Carotine beta | 0.01 | — | — |
| Orange compound | 10.00 | — | — |
| Citrus compound | — | 12.00 | — |
| Mandarine oil | — | — | 0.10 |
| terpene-free 10 | | | |
| vol.-% in Ethanol | | | |
| Orange Washing | — | — | 0.60 |
| Naringin ex | — | 0.10 | — |
| Grapefruit | | | |
| Lemon juice | — | 9.00 | — |
| concentrate | | | |
| Grapefruit juice | — | 7.00 | — |
| concentrate | | | |
| Orange juice | 7.00 | 3.00 | — |
| concentrate | | | |
| Flavouring | 0.03-0.08 | 0.03-0.08 | 0.01-0.03 |
| preparation from | (preferred | (preferred | (preferred |
| Table 1 0.1 wt.- | 0.05) | 0.05) | 0.05) |
| % in triacetin | | | |
| Carbonated | ad 1 L | ad 1 L | — |
| water (6 g/l | | | |
| CO2) | | | |
| Water | — | — | ad 1 L |

An orange or citrus compound describes a base composition for manufacturing softdrinks comprising an amount of 50 wt-% sugar and 15.5 wt.-% fruit acid and colorants.

An orange washing is the extraction product from extracting orange essential oil with food grade solvents (e.g. ethanol and water). 5

### 2. Macadamia Nut Oil

Table 5 shows the results of the tests with a flavouring composition obtained from macadamia nut oil as described in Examples 1 and 2.

TABLE 5
Results of the sensorial experiments with a flavouring
preparation manufactured from macadamia nut oil.

| Sample | Dosage | Odor | Taste |
|---|---|---|---|
| Essence oil orange | 25 ppm | fruity, essence, ripe, juicy, | fruity, essence, ripe, juicy, |
| | | slightly aldehydic | slightly aldehydic |
| Essence oil orange + | 25 ppm + | sweeter, fruitier, fuller, | sweeter, fuller , riper |
| flavouring composition | 0.5 ppm | more impact | |
| Essence oil tangerine | 12 ppm | fruity, methyl anthranilate, | fruity, methyl anthranilate, |
| | | juicy, slightly aldehydic- | juicy, slightly aldehydic- |
| | | fishy | fishy |
| Essence oil tangerine + | 12 ppm + | more impact, stronger, | mainly juicier |
| flavouring preparation | 0.5 ppm | juicier, bit more zesty | |

Additionally to testing the flavouring preparation in a model solution, the flavouring preparation was also added in dosing regimens of 0.015 to 0.05 ppm to commercially available citrus lemonades. The overall observed influence on the odor and the taste of the preparations was described by the panelists as that the addition of the flavouring preparation leads to a lift and more impact of the odor. Overall, the odor was a bit fresher and more zesty and conveys a bit more fatty-aldehydic, albedo-waxy notes. The taste is described as having more body, being more juicy and fuller with more fatty-aldehydic and albedo-waxy notes as desired for these types of beverages.

### Example 4: Formulation Examples and Sensorial Evaluation

The following tables show flavouring compositions according to the invention, their dosage in the final application and the effect on the taste and odour in the final application.

### 4.1 Lime Flavouring Composition

TABLE 6
Ingredients of a lime flavouring composition, its dosage in the final
application and the effect on taste and odour in the final application.

| Ingredient | Amount in g/100 g |
|---|---|
| Decanol | 0.10 |
| Decanal | 0.20 |
| Dodecanal | 0.30 |
| Borneol | 0.05 |
| Iso-Borneol | 0.10 |
| Camphene | 0.02 |
| Campheroil | 0.10 |
| trans-I-Carveol | 0.05 |
| Caryophyllene | 2.50 |
| Caryophyllenoxid | 0.30 |
| Citral | 0.50 |
| p-Cymene | 1.00 |
| Eucalyptol | 0.50 |
| Fenchol | 2.00 |
| Fenchone | 0.20 |
| Geranyl acetate | 0.05 |
| Linalool | 0.50 |
| Nerol | 0.06 |
| Neryl acetate | 2.50 |
| Ocimene | 0.20 |
| gamma-Terpinene | 3.00 |
| 4-Terpinenol | 4.00 |
| alpha-Terpineol | 25.00 |
| gamma-Terpineol | 4.00 |
| Terpinolene | 5.00 |
| Lime oil distilled | Q.S. |
| Flavouring preparation from borage | 0.01-0.10 (preferably 0.02) |
| seed oil 0.1 wt.-% in triacetin | |
| Dosage in final application | 25 ppm |
| Effect on taste and odour | fresher, more waxy, better |
| | mouthfeel |

### 4.2 Mandarine Flavouring Composition

TABLE 7
Ingredients of a mandarine flavouring preparation,
its dosage in the final application and the effect
on taste and odour in the final application.

| Ingredient | Amount in g/100 g |
|---|---|
| Decanol | 0.01 |
| Octanol | 0.05 |
| Octanal | 0.10 |
| Nonanal | 0.01 |
| Decanal | 0.05 |
| trans-I-Carveol | 0.01 |
| Caryophyllene | 0.10 |
| Citronellal | 0.01 |
| Citronellol | 0.01 |
| p-Cymene | 1.00 |
| 4Z-Decenal | 0.01 |
| 2E-Decenal | 0.01 |
| Methyl N-methyl anthranilate | 0.20 |
| 2E-Dodecenal | 0.01 |
| Linalool | 0.10 |
| Myrcene | 1.80 |
| Nerol | 0.01 |
| Perilla aldehyde replacer | 0.05 |
| alpha-Pinene | 3.00 |
| beta-Pinene | 1.50 |
| Sinensal fraction ex orange | 0.02 |
| gamma-Terpinene | 15.00 |
| 4-Terpinenol | 0.05 |
| alpha-Terpineol | 0.20 |
| Terpinolene | 1.00 |
| Thymol | 0.10 |
| Orange oil Brazilian | 30.00 |
| Flavouring preparation from borage | 0.03-0.20 (preferably 0.06) |
| seed oil 0.1 wt.-% in triacetin | |
| Dosage in final application | 20 ppm |
| Effect on taste and odour | more albedo, fatty, more body, |
| | more juiciness |

### 4.3 Kalamansi Flavouring Composition

TABLE 8
Ingredients of a kalamansi flavouring preparation,
its dosage in the final application and the effect
on taste and odour in the final application.

| Ingredient | Amount in g/100 g |
|---|---|
| Acetaldehyde | 0.2 |
| Decanol | 0.01 |
| Octanol | 0.10 |
| Decanal | 0.10 |
| Undecanal | 0.03 |
| Dodecanal | 0.02 |
| Caryophyllene | 0.10 |
| Citral | 0.50 |
| Citronellal | 0.02 |
| 2E,4E-Decadienal | 0.02 |
| 4Z-Decenal | 0.01 |
| Geranyl acetate | 0.10 |
| Linalool | 0.01 |
| Linalyl acetate | 0.10 |
| Mandarine oil Italian | 10.00 |
| Nerolidol | 0.02 |
| Alpha-pinene | 0.60 |
| 4-Terpinenol | 0.10 |
| alpha-Terpineol | 0.20 |
| Orange oil Brazilian | 30.00 |
| Tangerine oil | Q.S. |
| Flavouring preparation from borage | 0.01-0.10 (preferably 0.25) |
| seed oil 0.1 wt.-% in triacetin | |
| Dosage in final application | 80 ppm |
| Effect on taste and odour | more waxy-fatty, albedo, more |
| | impact, more body |

### 4.4 Tangerine Flavouring Composition

TABLE 9
Ingredients of a tangerine flavouring composition,
its dosage in the final application and the effect
on taste and odour in the final application.

| Ingredient | Amount in g/100 g |
|---|---|
| Dodecanal | 0.10 |
| 4Z-Decenal | 0.02 |
| 2E-Decenal | 0.02 |
| 2E-Dodecenal | 0.02 |
| Mandarine oil Italian | 5.00 |
| 2E,6Z -Nonadienal 1 wt.-% | 0.10 |
| 6Z-Nonenal 1 wt.-% | 0.02 |
| Orange oil bitter | 10.00 |
| Sinensal fraction ex orange | 0.20 |
| Orange oil Brazilian | 20.00 |
| Tangerine oil | Q.S. |
| Flavouring preparation from borage | 0.01-0.10 (preferably 0.025) |
| seed oil 0.1 wt.-% in triacetin | |
| Dosage in final application | 80 ppm |
| Effect on taste and odour | more waxy-fatty, albedo, more |
| | impact, more body |

### 4.5 Orange Flavouring Composition

TABLE 10
Ingredients of an orange flavouring composition,
its dosage in the final application and the effect
on taste and odour in the final application.

| Ingredient | Amount in g/100 g |
|---|---|
| Decanol | 0.08 |
| Hexanol | 0.01 |
| Octanol | 0.50 |
| Nonanol | 0.10 |
| Hexanal | 0.10 |
| Octanal | 1.00 |
| Nonanal | 0.20 |
| Decanal | 1.00 |
| Dodecanal | 0.20 |
| Caprylic acid | 0.10 |
| trans-I-Carveol | 0.25 |
| Caryophyllene | 0.04 |
| Caryophyllenoxid | 0.10 |
| Citral | 0.50 |
| Citronellal | 0.15 |
| Citronellol | 0.07 |
| 2E-Decenal | 0.02 |
| Ethyl butyrate | 0.20 |
| Ethyl caprylate | 0.02 |
| 2-Ethyl methylbutyrate | 0.02 |
| Geraniol | 0.03 |
| 2E-Hexenal | 0.02 |
| Linalool | 3.00 |
| Myrcene | 1.80 |
| Nerol | 0.05 |
| Nootkatone | 0.10 |
| 1-Octyl acetate | 0.07 |
| Orange essence oil Florida | 50.00 |
| Perilla aldehyde replacer | 0.15 |
| Sinensal fraction ex orange | 0.50 |
| Valencene fraction ex orange | 1.00 |
| Orange oil Brazilian | Q.S. |
| Flavouring preparation from borage | 0.03-0.15 (preferably 0.055) |
| seed oil 0.1 wt.-% in triacetin | |
| Dosage in final application | 40 ppm |
| Effect on taste and odour | sweeter, fuller, aldehydic, more |
| | juicy-fruity, riper |

### 4.6 Grapefruit Flavouring Composition

TABLE 11
Ingredients of a grapefruit flavouring composition,
its dosage in the final application and the effect
on taste and odour in the final application.

| Ingredient | Amount in g/100 g |
|---|---|
| Decanol | 0.02 |
| Octanol | 0.20 |
| Octanal | 0.50 |
| Nonanal | 0.10 |
| Decanal | 0.60 |
| Dodecanal | 0.05 |
| Capric acid | 0.10 |
| Caprylic acid | 0.05 |
| trans-I-Carveol | 0.04 |
| trans-Carvyl acetate | 0.05 |
| Caryophyllene | 0.40 |
| Citral | 0.20 |
| Citronellal | 0.05 |
| p-Cymene | 0.20 |
| Geraniol | 0.02 |
| Geranyl acetate | 0.08 |
| Grapefruit oil white | 60.00 |
| Heptyl acetate | 0.04 |
| Linalool | 0.40 |
| 1,8-Menthenthiol 1 wt.-% in limonen | 0.70 |
| Myrcene | 1.80 |
| Nootkatone | 0.40 |
| Ocimene | 0.50 |
| 1-Octyl acetate | 0.10 |
| Palmitic acid | 0.08 |
| Perilla aldehyde replacer | 0.04 |
| alpha-Pinene | 1.00 |
| beta-Pinene | 0.25 |
| alpha-Terpineol | 0.15 |
| Terpinolene | 0.01 |
| Valencene fraction ex orange | 0.30 |
| Orange oil Brazilian | Q.S. |
| Flavouring preparation from borage | 0.01-0.15 |
| seed oil 0.1 wt.-% in triacetin | |
| Dosage in final application | 25 ppm |
| Effect on taste and odour | more albedo-waxy, more impact, |
| | sweeter |

### 4.7 Lemon Flavouring Composition

TABLE 12
Ingredients of a lemon flavouring composition,
its dosage in the final application and the effect
on taste and odour in the final application.

| Ingredient | Amount in g/100 g |
|---|---|
| Decanol | 0.20 |
| Nonanol | 0.10 |
| Octanal | 0.20 |
| Nonanal | 0.80 |
| Decanal | 0.40 |
| Undecanal | 0.10 |
| Dodecanal | 0.05 |
| Borneol | 0.04 |
| Campheroil | 0.05 |
| Capric acid | 0.04 |
| Caryophyllene | 0.03 |
| Citral | 10.00 |
| Citronellal | 0.10 |
| Citronellol | 0.04 |
| Citronellyl acetate | 0.02 |
| Eucalyptol | 0.20 |
| Geraniol | 0.05 |
| Geranyl acetate | 0.50 |
| Hotrienol | 0.02 |
| Linalool | 0.20 |
| Linoleicacid | 0.10 |
| Nerol | 0.10 |
| Neryl acetate | 2.00 |
| Palmitic acid | 0.10 |
| 4-Terpinenol, | 0.20 |
| alpha-Terpineol, | 0.20 |
| Lime juice oil | 20.00 |
| Lemon oil Italian | Q.S. |
| Flavouring preparation from borage | 0.01-0.10 |
| seed oil | |
| Dosage in final application | 50 ppm |
| Effect on taste and odour | more waxy, residue notes, slightly |
| | more juicy |

1-14. (canceled)

15. A flavoring composition comprising a combination of aldehydes, wherein the combination of aldehydes comprises:
8Z, 11Z-heptadecadienal;
8Z-heptadecenal;
7Z-Hexadecenal; and
optionally, one or more compounds selected from 5Z, 8Z, 12Z-heptadecatrienal, 8Z-pentadecenal, 7Z-tetradecenal, or combinations thereof.

16. The flavoring composition of claim 15 comprising
0.0001 to 30 wt. % of 8Z, 11Z-heptadecadienal;
0.0001 to 30 wt. % or 8Z-heptadecenal;
0.0001 to 30 wt.-% of 7Z-hexadecenal;
if present, 0.0001 to 20 wt. % of 5Z, 8Z, 12Z-heptadecatrienal;
if present, 0.0001 to 20 wt. % of 8Z-pentadecenal; and/or
if present, 0.0001 to 20 wt. % of 7Z-tetradecenal;
in each case based on the total weight of the flavoring composition.

17. The flavoring composition of claim 15, wherein one or more of the aldehydes are obtained by enzymatic conversion of palmitoleic acid, arachidonic acid, alpha-linolenic acid, oleic acid, punicic acid, alpha-elaeosteraric acid, docosahexaenoic acid, eicosapentaenoic acid, petroselic acid, chaulmoogric acid, alpha-licaric acid, olive oil, canola oil, macadamia nut oil, sea buckthorn fruit oil, tung oil, fish oil, borage oil, chaulmoogr oil, parsley oil, oiticica oil, pomegranate seed oil, coconut oil, sunflower oil, grape seed oil, and fungal oils obtained from any of the genera selected from Conidiobolus, Flammulina, Fomes, Ganoderma, Mortierella, Panellus, Pleurotus, Psathyrella, Stereum, Umbelopsis.

18. The flavoring composition of claim 15, wherein the flavoring composition further comprises one or more additional flavorings selected from aliphatic flavoring substances, aliphatic aldehydes, mono- or multi-unsaturated aliphatic aldehydes, aliphatic ketones, unsaturated ketones, aliphatic diketones and aliphatic diketoles, aliphatic acids, branched-chain saturated acids, aliphatic esters, unsaturated esters, aliphatic sulfur compounds, aliphatic nitrogen compounds, alicyclic compounds, alicyclic esters, terpene alcohols, terpene ketones, terpene esters, terpene hydrocarbons, aromatic compounds, aromatic aldehydes, aromatic acids, aromatic esters, aromatic sulphur compounds, aromatic ethers, aromatic oxides, aromatic lactones, heterocyclic compounds, heterocyclic furanes, heterocyclic pyrans, heterocyclic pyrroles, heterocyclic pyrazines, heterocyclic thiazoles, or mixtures thereof.

19. The flavoring composition of claim 15, further comprising one or more essential oils, concretes, absolutes, extracts, tinctures, or mixtures thereof.

20. The flavoring composition of claim 15, further comprising one or more juice concentrates.

21. The flavoring composition of claim 15, further comprising one or more flavorings selected from acetophenone, allyl caproate, alpha-ionone, beta-ionone, anisaldehyde, anisyl acetate, anisyl formate, benzaldehyde, benzothiazole, benzyl acetate, benzyl alcohol, benzyl benzoate, beta-ionone, butyl butyrate, butyl caproate, butylidene phthalide, carvone, camphene, caryophyllene, cineol, cinnamyl acetate, citral, citronellol, citronellal, citronellyl acetate, cyclohexyl acetate, cymene, damascone, decalactone, dihydrocoumarin, dimethyl anthranilate, dodecalactone, ethoxyethyl acetate, ethylbutyric acid, ethyl butyrate, ethyl caprate, ethyl caproate, ethyl crotonate, ethylfuraneol, ethylguaiacol, ethylisobutyrate, ethylisovalerate, ethyl lactate, ethylmethyl butyrate, ethyl propionate, eucalyptol, eugenol, ethyl heptylate, 4-(p-hydroxyphenyl)-2-butanone, gamma-decalactone, geraniol, geranyl acetate, geranyl acetate, grapefruit aldehyde, methyl dihydrojasmonate, heliotropin, 2-heptanone, 3-heptanone, 4-heptanone, 2E-heptenal, 4Z-heptenal, 2E-hexenal, 3Z-hexenol, 2E-hexenoic acid, 3E-hexenoic acid, 2Z-hexenyl acetate, 3Z-hexenyl acetate, 3Z-hexenyl caproate, 2E-hexenyl caproate, 3Z-hexenyl formate, 2Z-hexyl acetate, 3Z-hexyl acetate, 2E-hexyl acetate, 3Z-hexyl formate, para-hydroxybenzyl acetone, isoamyl alcohol, isoamyl isovalerate, isobutyl butyrate, isobutyraldehyde, isoeugenol methyl ether, isopropyl methylthiazole, lauric acid, levulinic acid, linalool, linalool oxide, linalyl acetate, menthol, menthofuran, methyl anthranilate, methylbutanol, methylbutyric acid, 2-methylbutyl acetate, methyl caproate, methyl cinnamate, 5-methylfurfural, 3,2,2-methylcyclopentenolone, 6,5,2-methylheptenone, methyl dihydrojasmonate, methyl jasmonate, 2-methylmethyl butyrate, 2-methyl-2-pentenol acid, methylthiobutyrate, 3,1-methylthiohexanol, 3-methylthiohexyl acetate, nerol, nerol acetate, 2E, 4E-nonadienal, 2,4-nonadienol, 2,6-nonadienol, 2,4-nonadienol, nootkatone, delta-octalactone, gamma-octalactone, 2-octanol, 3-octanol, 1,3-octenol, 1-octyl acetate, 3-octyl acetate, palmitic acid, paraldehyde, phellandrene, pentanedione, phenylethyl acetate, phenylethyl alcohol, phenylethyl isovalerate, piperonal, propionaldehyde, propyl butyrate, pulegone, pulegol, sinensal, sulfurol, terpinene, terpineol, terpinolene, 8,3-s thiomenthanone, 4,4,2-thiomethylpentanone, thymol, delta-undecalactone, gamma-undecalactone, valencene, valeric acid, vanillin, acetoin, ethylvanillin, ethylvanillin isobutyrate (=3-ethoxy-4-isobutyryloxybenzaldehyde), 2,5-dimethyl-4-hydroxy-3 (2H)-furanone and derivatives thereof, maltol and maltol derivatives, coumarin and coumarin derivatives, gamma-lactones, delta-lactones, methyl sorbate, divanillin, 4-hydroxy-2 (or 5)-ethyl-5 (or 2)-methyl-3 (2H) furanone, 2-hydroxy-3-methyl-2-cyclopentenone, 3-hydroxy-4,5-dimethyl-2 (5H)-furanone, acetic acid isoamyl ester, butyric acid ethyl ester, butyric acid-n-butyl ester, butyric acid isoamyl ester, 3-methyl-butyric acid ethyl ester, n-hexanoic acid ethyl ester, n-hexanoic acid allyl ester, n-hexanoic acid-n-butyl ester, n-octanoic acid ethyl ester, ethyl-3-methyl-3-phenylglycidate, ethyl-2-E-4-Z-decadienoate, 4-(p-hydroxyphenyl)-2-butanone, 1,1-dimethoxy-2,2,5-trimethyl-4-hexane, 2,6-dimethyl-5-hepten-1-al and phenylacetaldehyde, 2-methyl-3-(methylthio) furan, 2-methyl-3-furanthiol, bis(2-methyl-3-furyl)disulphide, furfurylmercaptan, methional, 2-acetyl-2-thiazoline, 3-mercapto-2-pentanone, 2,5-dimethyl-3-furanthiol, 2,4,5-trimethylthiazole, 2-acetylthiazole, 2,4-dimethyl-5-ethylthiazole, 2-acetyl-1-pyrroline, 2-methyl-3-ethylpyrazine, 2-ethyl-3,5-dimethylpyrazine, 2-ethyl-3,6-dimethylpyrazine, 2,3-diethyl-5-methylpyrazine, 3-isopropyl-2-methoxypyrazine, 3-isobutyl-2-methoxypyrazine, 2-acetylpyrazine, 2-pentylpyridine, (E,E)-2,4-decadienal, (E,E)-2,4-nonadienal, (E)-2-octenal, (E)-2-nonenal, 2-undecenal, 12-methyltridecanal, 1-penten-3-one, 4-hydroxy-2,5-dimethyl-3 (2H)-furanone, guaiacol, 3-hydroxy-4,5-dimethyl-2 (5H)-furanone, 3-hydroxy-4-methyl-5-ethyl-2 (5H)-furanone, cinnamaldehyde, cinnamon alcohol, methyl salicylate, isopulegol and (here not explicitly stated) stereoisomers, enantiomers, positional isomers, diastereomers, ZIE isomers or epimers thereof.

22. The flavoring composition of claim 15, further comprising one or more compounds conveying a sweet taste.

23. The flavoring composition of claim 15, wherein the one or more compounds conveying a sweet taste are selected from natural sweeteners.

24. The flavoring composition of claim 15, wherein the one or more compounds conveying a sweet taste are selected from synthetic sweeteners.

25. A preparation comprising the flavoring composition of claim 15 in an amount of 0.001 to 10 ppm, based on the total weight of the preparation.

26. The preparation of claim 25, wherein the preparation is a preparation suitable for consumption, a preparation for pleasure, a beverage, a semi-finished product, or an oral hygiene product.

27. The preparation of claim 25, further comprising one or more additional flavorings selected from aliphatic flavoring substances, aliphatic aldehydes, mono- or multi-unsaturated aliphatic aldehydes, aliphatic ketones, unsaturated ketones, aliphatic diketones and aliphatic diketoles, aliphatic acids, branched-chain saturated acids, aliphatic esters, unsaturated esters, aliphatic sulfur compounds, aliphatic nitrogen compounds, alicyclic compounds, alicyclic esters, terpene alcohols, terpene ketones, terpene esters, terpene hydrocarbons, aromatic compounds, aromatic aldehydes, aromatic acids, aromatic esters, aromatic sulphur compounds, aromatic ethers, aromatic oxides, aromatic lactones, heterocyclic compounds, heterocyclic furanes, heterocyclic pyrans, heterocyclic pyrroles, heterocyclic pyrazines, heterocyclic thiazoles, or mixtures thereof.

28. The preparation of claim 25, further comprising one or more essential oils, concretes, absolutes, extract, tinctures, or mixtures thereof.

29. The preparation of claim 25, further comprising one or more juice concentrates.

30. The preparation of claim 25, further comprising one or more flavorings selected from acetophenone, allyl caproate, alpha-ionone, beta-ionone, anisaldehyde, anisyl acetate, anisyl formate, benzaldehyde, benzothiazole, benzyl acetate, benzyl alcohol, benzyl benzoate, beta-ionone, butyl butyrate, butyl caproate, butylidene phthalide, carvone, camphene, caryophyllene, cineol, cinnamyl acetate, citral, citronellol, citronellal, citronellyl acetate, cyclohexyl acetate, cymene, damascone, decalactone, dihydrocoumarin, dimethyl anthranilate, dodecalactone, ethoxyethyl acetate, ethylbutyric acid, ethyl butyrate, ethyl caprate, ethyl caproate, ethyl crotonate, ethylfuraneol, ethylguaiacol, ethylisobutyrate, ethylisovalerate, ethyl lactate, ethylmethyl butyrate, ethyl propionate, eucalyptol, eugenol, ethyl heptylate, 4-(p-hydroxyphenyl)-2-butanone, gamma-decalactone, geraniol, geranyl acetate, geranyl acetate, grapefruit aldehyde, methyl dihydrojasmonate, heliotropin, 2-heptanone, 3-heptanone, 4-heptanone, 2E-heptenal, 4Z-heptenal, 2E-hexenal, 3Z-hexenol, 2E-hexenoic acid, 3E-hexenoic acid, 2Z-hexenyl acetate, 3Z-hexenyl acetate, 3Z-hexenyl caproate, 2E-hexenyl caproate, 3Z-hexenyl formate, 2Z-hexyl acetate, 3Z-hexyl acetate, 2E-hexyl acetate, 3Z-hexyl formate, para-hydroxybenzyl acetone, isoamyl alcohol, isoamyl isovalerate, isobutyl butyrate, isobutyraldehyde, isoeugenol methyl ether, isopropyl methylthiazole, lauric acid, levulinic acid, linalool, linalool oxide, linalyl acetate, menthol, menthofuran, methyl anthranilate, methylbutanol, methylbutyric acid, 2-methylbutyl acetate, methyl caproate, methyl cinnamate, 5-methylfurfural, 3,2,2-methylcyclopentenolone, 6,5,2-methylheptenone, methyl dihydrojasmonate, methyl jasmonate, 2-methylmethyl butyrate, 2-methyl-2-pentenol acid, methylthiobutyrate, 3,1-methylthiohexanol, 3-methylthiohexyl acetate, nerol, nerol acetate, 2E, 4E-nonadienal, 2,4-nonadienol, 2,6-nonadienol, 2,4-nonadienol, nootkatone, delta-octalactone, gamma-octalactone, 2-octanol, 3-octanol, 1,3-octenol, 1-octyl acetate, 3-octyl acetate, palmitic acid, paraldehyde, phellandrene, pentanedione, phenylethyl acetate, phenylethyl alcohol, phenylethyl isovalerate, piperonal, propionaldehyde, propyl butyrate, pulegone, pulegol, sinensal, sulfurol, terpinene, terpineol, terpinolene, 8,3-s thiomenthanone, 4,4,2-thiomethylpentanone, thymol, delta-undecalactone, gamma-undecalactone, valencene, valeric acid, vanillin, acetoin, ethylvanillin, ethylvanillin isobutyrate (=3-ethoxy-4-isobutyryloxybenzaldehyde), 2,5-dimethyl-4-hydroxy-3 (2H)-furanone and derivatives thereof, maltol and maltol derivatives, coumarin and coumarin derivatives, gamma-lactones, delta-lactones, methyl sorbate, divanillin, 4-hydroxy-2 (or 5)-ethyl-5 (or 2)-methyl-3 (2H) furanone, 2-hydroxy-3-methyl-2-cyclopentenone, 3-hydroxy-4,5-dimethyl-2 (5H)-furanone, acetic acid isoamyl ester, butyric acid ethyl ester, butyric acid-n-butyl ester, butyric acid isoamyl ester, 3-methyl-butyric acid ethyl ester, n-hexanoic acid ethyl ester, n-hexanoic acid allyl ester, n-hexanoic acid-n-butyl ester, n-octanoic acid ethyl ester, ethyl-3-methyl-3-phenylglycidate, ethyl-2-E-4-Z-decadienoate, 4-(p-hydroxyphenyl)-2-butanone, 1,1-dimethoxy-2,2,5-trimethyl-4-hexane, 2,6-dimethyl-5-hepten-1-al and phenylacetaldehyde, 2-methyl-3-(methylthio) furan, 2-methyl-3-furanthiol, bis(2-methyl-3-furyl)disulphide, furfurylmercaptan, methional, 2-acetyl-2-thiazoline, 3-mercapto-2-pentanone, 2,5-dimethyl-3-furanthiol, 2,4,5-trimethylthiazole, 2-acetylthiazole, 2,4-dimethyl-5-ethylthiazole, 2-acetyl-1-pyrroline, 2-methyl-3-ethylpyrazine, 2-ethyl-3,5-dimethylpyrazine, 2-ethyl-3,6-dimethylpyrazine, 2,3-diethyl-5-methylpyrazine, 3-isopropyl-2-methoxypyrazine, 3-isobutyl-2-methoxypyrazine, 2-acetylpyrazine, 2-pentylpyridine, (E,E)-2,4-decadienal, (E,E)-2,4-nonadienal, (E)-2-octenal, (E)-2-nonenal, 2-undecenal, 12-methyltridecanal, 1-penten-3-one, 4-hydroxy-2,5-dimethyl-3 (2H)-furanone, guaiacol, 3-hydroxy-4,5-dimethyl-2 (5H)-furanone, 3-hydroxy-4-methyl-5-ethyl-2 (5H)-furanone, cinnamaldehyde, cinnamon alcohol, methyl salicylate, isopulegol and (here not explicitly stated) stereoisomers, enantiomers, positional isomers, diastereomers, ZIE isomers or epimers thereof.

31. The preparation of claim 25, further comprising one or more compounds conveying a sweet taste selected from natural sweeteners, synthetic sweeteners, or mixtures thereof.

32. A method for improving one or more taste characteristics of a preparation comprising:
(a) providing a preparation suitable for consumption, a preparation for pleasure, a beverage, a semi-finished product, or an oral hygiene product;
(b) providing the flavoring composition of claim 15;
(c) contacting and mixing the preparation with the flavoring composition; and
(d) obtaining a preparation with one or more improved taste characteristics.

33. The method of claim 32, wherein the flavoring composition of (b) is in an amount of from 0.001 to 10 ppm, based on the total weight of the preparation.

34. The method of claim 32, wherein at least one of the one or more taste characteristics is richness, body, authenticity, impact, mouthfeel, sweetness, or juiciness.
